(19) United States
(12) Patent Application Publication
(10) Pub. No.: US 2022/0086946 A1
(43) Pub. Date: Mar. 17, 2022

(54) METHOD AND APPARATUS FOR SMALL DATA TRANSMISSION IN A WIRELESS COMMUNICATION SYSTEM

(71) Applicant: ASUSTek Computer Inc., Taipei City (TW)

(72) Inventors: Yi-Hsuan Huang, Taipei City (TW); Meng-Hui OU, Taipei City (TW); Yu-Hsuan GUO, Taipei City (TW)

(21) Appl. No.: 17/463,719

(22) Filed: Sep. 1, 2021

Related U.S. Application Data
(60) Provisional application No. 63/079,618, filed on Sep. 17, 2020.
(60) Provisional application No. 63/079,629, filed on Sep. 17, 2020.

(51) Int. Cl. H04W 76/27; H04W 72/12; H04W 72/14

(52) U.S. Cl. CPC H04W 76/27; H04W 72/14; H04W 72/1289

(57) ABSTRACT

A method and apparatus are disclosed. In an example from the perspective of a User Equipment (UE), the UE receives, when the UE is in Radio Resource Control (RRC) connected state, a first Radio Network Temporary Identifier (RNTI) in a first RRC message. The UE monitors, when the UE is in RRC connected state, a Physical Downlink Control Channel (PDCCH) using the first RNTI. The UE receives a second RRC message indicative of the UE transitioning from RRC connected state to RRC inactive state. The UE determines an RNTI, comprising the first RNTI or a second RNTI, based on whether or not the second RRC message comprises the second RNTI. The UE monitors, when the UE is in RRC inactive state, the PDCCH using the RNTI.

### CROSS-REFERENCE TO RELATED APPLICATIONS

The present application claims the benefit of U.S. Provisional Patent Application Ser. No. 63/079,618 filed on Sep. 17, 2020, the entire disclosure of which is incorporated herein in its entirety by reference. The present application also claims the benefit of U.S. Provisional Patent Application Ser. No. 63/079,629 filed on Sep. 17, 2020, the entire disclosure of which is incorporated herein in its entirety by reference.

### FIELD

This disclosure generally relates to wireless communication networks, and more particularly, to a method and apparatus for small data transmission in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a User Equipment (UE), the UE receives, when the UE is in Radio Resource Control (RRC) connected state, a first Radio Network Temporary Identifier (RNTI) in a first RRC message. The UE monitors, when the UE is in RRC connected state, a Physical Downlink Control Channel (PDCCH) using the first RNTI. The UE receives a second RRC message indicative of the UE transitioning from RRC connected state to RRC inactive state. The UE determines an RNTI, comprising the first RNTI or a second RNTI, based on whether or not the second RRC message comprises the second RNTI. The UE monitors, when the UE is in RRC inactive state, the PDCCH using the RNTI.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram illustrating an exemplary scenario associated with successful Radio Resource Control (RRC) connection release according to one exemplary embodiment.

FIG. 6A is a diagram illustrating an exemplary scenario associated with a small data transmission procedure (SDT procedure) with subsequent data according to one exemplary embodiment.

FIG. 6B is a diagram illustrating an exemplary scenario associated with a SDT procedure with subsequent data according to one exemplary embodiment.

FIG. 7A is a diagram illustrating an exemplary scenario associated with a SDT procedure with subsequent data according to one exemplary embodiment.

FIG. 7B is a diagram illustrating an exemplary scenario associated with a SDT procedure with subsequent data according to one exemplary embodiment.

FIG. 8A is a diagram illustrating an exemplary scenario associated with a SDT procedure with subsequent data according to one exemplary embodiment.

FIG. 8B is a diagram illustrating an exemplary scenario associated with a SDT procedure with subsequent data according to one exemplary embodiment.

FIG. 9A is a diagram illustrating an exemplary scenario associated with a SDT procedure with subsequent data according to one exemplary embodiment.

FIG. 9B is a diagram illustrating an exemplary scenario associated with a SDT procedure with subsequent data according to one exemplary embodiment.

FIG. 10 is a diagram illustrating an exemplary scenario associated with a SDT procedure with subsequent data according to one exemplary embodiment.

FIG. 11 is a diagram illustrating an exemplary scenario associated with a SDT procedure with subsequent data according to one exemplary embodiment.

FIG. 12 is a diagram illustrating an exemplary scenario associated with a SDT procedure with subsequent data according to one exemplary embodiment.

FIG. 13 is a flow chart according to one exemplary embodiment.

FIG. 14 is a flow chart according to one exemplary embodiment.

FIG. 15 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: RP-193252, “New Work Item on NR small data transmissions in INACTIVE state”; R2-2008124, “Report for Rel-16 (NR-U, Power Savings and 2-step RACH) and Rel-17 (IIoT and Small Data)”; 3GPP TS 38.321 V16.1.0, “NR, MAC protocol specification”; 3GPP TS 38.331 V16.1.0, “NR, RRC protocol specification”; R2-2007047, “Discussion on UL small data transmissions for RACH-based schemes”; R2-2007540, “RACH based NR small data transmission”; RP-193238, “New SID on support of reduced capability NR devices”. The standards and documents listed above are hereby expressly incorporated by reference in their entirety.

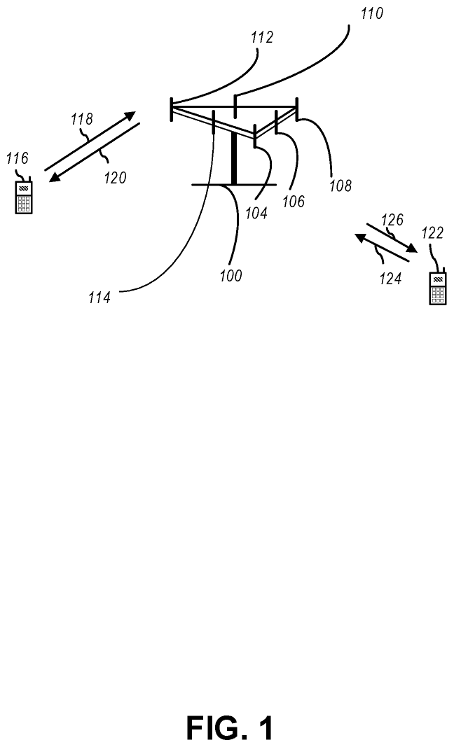

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

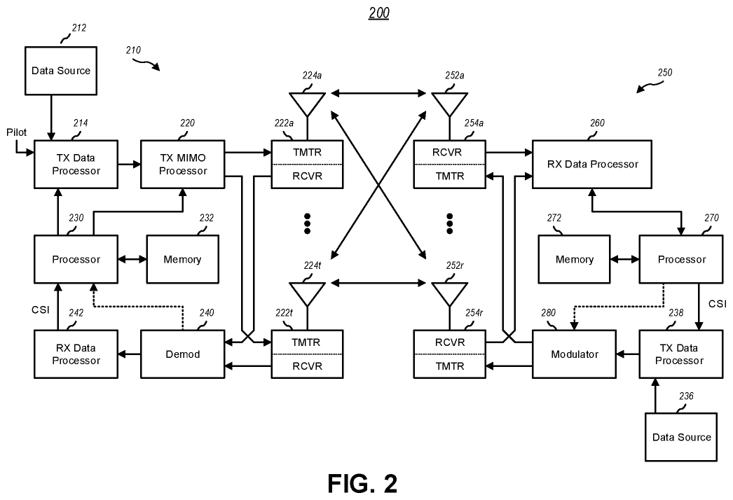

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the N_{R} received symbol streams from N_{R} receivers 254 based on a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

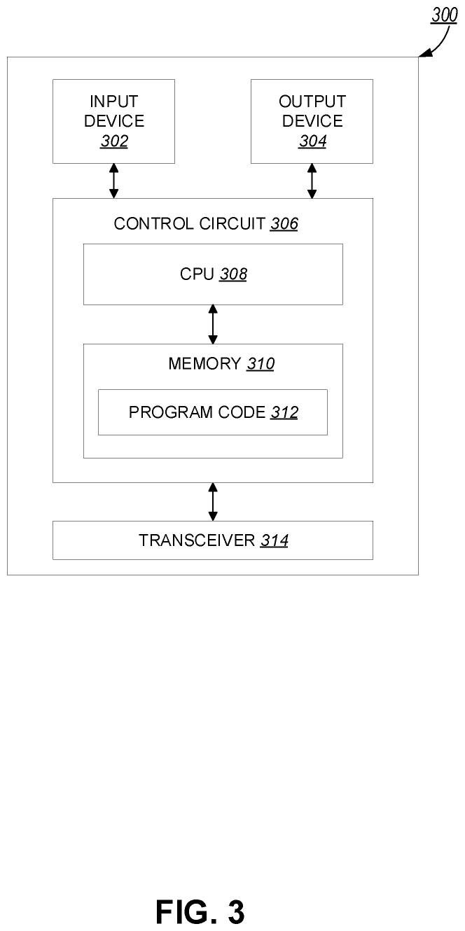

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

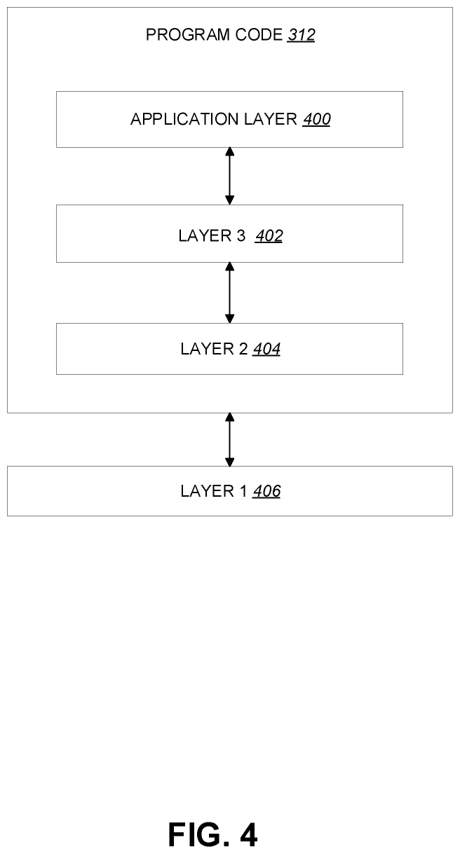

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

A work item of small data transmission in NR has been approved in RAN plenary #86 meeting. The description of the work item is provided in one or more parts of RP-193252 quoted below:

### 3 Justification

NR supports RRC_INACTIVE state and UEs with infrequent (periodic and/or non-periodic) data transmission are generally maintained by the network in the RRC_INACTIVE state. Until Rel-16, the RRC_INACTIVE state doesn't support data transmission. Hence, the UE has to resume the connection (i.e. move to RRC_CONNECTED state) for any DL (MT) and UL (MO) data. Connection setup and subsequently release to INACTIVE state happens for each data transmission however small and infrequent the data packets are. This results in unnecessary power consumption and signalling overhead.

[ . . . ]

Signalling overhead from INACTIVE state UEs for small data packets is a general problem and will become a critical issue with more UEs in NR not only for network performance and efficiency but also for the UE battery performance. In general, any device that has intermittent small data packets in INACTIVE state will benefit from enabling small data transmission in INACTIVE.

The key enablers for small data transmission in NR, namely the INACTIVE state, 2-step, 4-step RACH and configured grant type-1 have already been specified as part of Rel-15 and Rel-16. So, this work builds on these building blocks to enable small data transmission in INACTIVE state for NR.

### 4 Objective

### 4.1 Objective of SI or Core Part WI or Testing Part WI

This work item enables small data transmission in RRC_INACTIVE state as follows:
For the RRC_INACTIVE state:
   UL small data transmissions for RACH-based schemes (i.e. 2-step and 4-step RACH):
      General procedure to enable UP data transmission for small data packets from INACTIVE state (e.g. using MSGA or MSG3) [RAN2]
      Enable flexible payload sizes larger than the Rel-16 CCCH message size that is possible currently for INACTIVE state for MSGA and MSG3 to support UP data transmission in UL (actual payload size can be up to network configuration) [RAN2]
      Context fetch and data forwarding (with and without anchor relocation) in INACTIVE state for RACH-based solutions [RAN2, RAN3]
   Note 1: The security aspects of the above solutions should be checked with SA3
   Transmission of UL data on pre-configured PUSCH resources (i.e. reusing the configured grant type 1)—when TA is valid
      General procedure for small data transmission over configured grant type 1 resources from INACTIVE state [RAN2]
      Configuration of the configured grant type1 resources for small data transmission in UL for INACTIVE state [RAN2]
         No new RRC state should be introduced in this WID. Transmission of small data in UL, subsequent transmission of small data in UL and DL and the state transition decisions should be under network control.

In RAN2 #111 e-meeting, the following agreements were reached and captured in a session report quoted below from R2-2008124:

Agreements

| | |
|---|---|
| 9 | UL/DL transmission following UL SDT without transitioning to |
| | RRC_CONNECTED is supported |
| 10 | When UE is in RRC_INACTIVE, it should be possible to send |
| | multiple UL and DL packets as part of the same SDT mechanism |
| | and without transitioning to RRC_CONNECTED on dedicated |
| | grant. FFS on details and whether any indication to network is |
| | needed. |

In NR, an uplink (UL) transmission in a configured UL grant is discussed in one or more parts of 3GPP TS 38.321 V16.1.0 quoted below:

### 5.4 UL-SCH Data Transfer

### 5.4.1 UL Grant Reception

Uplink grant is either received dynamically on the PDCCH, in a Random Access Response, configured semi-persistently by RRC or determined to be associated with the PUSCH resource of MSGA as specified in clause 5.1.2a. The MAC entity shall have an uplink grant to transmit on the UL-SCH. To perform the requested transmissions, the MAC layer receives HARQ information from lower layers. An uplink grant addressed to CS-RNTI with NDI=0 is considered as a configured uplink grant. An uplink grant addressed to CS-RNTI with NDI=1 is considered as a dynamic uplink grant.

If the MAC entity has a C-RNTI, a Temporary C-RNTI, or CS-RNTI, the MAC entity shall for each PDCCH occasion and for each Serving Cell belonging to a TAG that has a running timeAlignmentTimer and for each grant received for this PDCCH occasion:
1> if an uplink grant for this Serving Cell has been received on the PDCCH for the MAC entity's C-RNTI or Temporary C-RNTI; or
1> if an uplink grant has been received in a Random Access Response:
   2> if the uplink grant is for MAC entity's C-RNTI and if the previous uplink grant delivered to the HARQ entity for the same HARQ process was either an uplink grant received for the MAC entity's CS-RNTI or a configured uplink grant:
      3> consider the NDI to have been toggled for the corresponding HARQ process regardless of the value of the NDI.
   2> if the uplink grant is for MAC entity's C-RNTI, and the identified HARQ process is configured for a configured uplink grant:
      3> start or restart the configuredGrantTimer for the correponding HARQ process, if configured.
      3> stop the cg-RetransmissionTimer for the correponding HARQ process, if running
   2> deliver the uplink grant and the associated HARQ information to the HARQ entity.
1> else if an uplink grant for this PDCCH occasion has been received for this Serving Cell on the PDCCH for the MAC entity's CS-RNTI:
   2> if the NDI in the received HARQ information is 1:
      3> consider the NDI for the corresponding HARQ process not to have been toggled;
      3> start or restart the configuredGrantTimer for the corresponding HARQ process, if configured;
      3> stop the cg-RetransmissionTimer for the correponding HARQ process, if running;
      3> deliver the uplink grant and the associated HARQ information to the HARQ entity.
   2> else if the NDI in the received HARQ information is 0:
      3> if PDCCH contents indicate configured grant Type 2 deactivation:
         4> trigger configured uplink grant confirmation.
      3> else if PDCCH contents indicate configured grant Type 2 activation:
         4> trigger configured uplink grant confirmation;
         4> store the uplink grant for this Serving Cell and the associated HARQ information as configured uplink grant;
         4> initialise or re-initialise the configured uplink grant for this Serving Cell to start in the associated PUSCH duration and to recur according to rules in clause 5.8.2;
         4> stop the configuredGrantTimer for the corresponding HARQ process, if running;
         4> stop the cg-RetransmissionTimer for the correponding HARQ process, if running.

For each Serving Cell and each configured uplink grant, if configured and activated, the MAC entity shall:
1> if the MAC entity is configured with lch-basedPrioritization, and the PUSCH duration of the configured uplink grant does not overlap with the PUSCH duration of an uplink grant received in a Random Access Response for this Serving Cell or with a transmission of MSGA payload; or
1> if the PUSCH duration of the configured uplink grant does not overlap with the PUSCH duration of an uplink grant received on the PDCCH or in a Random Access Response for this Serving Cell or with the PUSCH duration of a MSGA payload:
   2> set the HARQ Process ID to the HARQ Process ID associated with this PUSCH duration;
   2> if, for the corresponding HARQ process, the configuredGrantTimer is not running and cg-RetransmissionTimer is not configured (i.e. new transmission):
      3> consider the NDI bit for the corresponding HARQ process to have been toggled;
      3> deliver the configured uplink grant and the associated HARQ information to the HARQ entity.
   2> else if the cg-RetransmissionTimer for the corresponding HARQ process is configured and not running, then for the corresponding HARQ process:
      3> if the configuredGrantTimer is not running, and the HARQ process is not pending (i.e. new transmission):
         4> consider the NDI bit to have been toggled;
         4> deliver the configured uplink grant and the associated HARQ information to the HARQ entity.
      3> else if the previous uplink grant delivered to the HARQ entity for the same HARQ process was a configured uplink grant (i.e. retransmission on configured grant):
         4> deliver the configured uplink grant and the associated HARQ information to the HARQ entity.

For configured uplink grants neither configured with harq-ProcID-Offset2 nor with cg-RetransmissionTimer, the HARQ Process ID associated with the first symbol of a UL transmission is derived from the following equation:

HARQ Process ID=[floor(CURRENT_symbol/periodicity)]modulo nrofHARQ-Processes

For configured uplink grants with harq-ProcID-Offset2, the HARQ Process ID associated with the first symbol of a UL transmission is derived from the following equation:

HARQ Process ID=[floor(CURRENT_symbol/periodicity)]modulo nrofHARQ-Processes+harq-ProcID-Offset2

where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211 [8].

For configured uplink grants configured with cg-RetransmissionTimer, the UE implementation select an HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.
NOTE 1: CURRENT_symbol refers to the symbol index of the first transmission occasion of a repetition bundle that takes place.
NOTE 2: A HARQ process is configured for a configured uplink grant where neither harq-ProcID-Offset nor harq-ProcID-Offset2 is configured, if the configured uplink grant is activated and the associated HARQ process ID is less than nrofHARQ-Processes. A HARQ process is configured for a configured uplink grant where harq-ProcID-Offset2 is configured, if the configured uplink grant is activated and the associated HARQ process ID is greater than or equal to harq-ProcID-Offset2 and less than sum of harq-ProcID-Offset2 and nrofHARQ-Processes for the configured grant configuration.
NOTE 3: If the MAC entity receives a grant in a Random Access Response (i.e. MAC RAR or fallbackRAR) or determines a grant as specified in clause 5.1.2a for MSGA payload and if the MAC entity also receives an overlapping grant for its C-RNTI or CS-RNTI, requiring concurrent transmissions on the SpCell, the MAC entity may choose to continue with either the grant for its RA-RNTI/MSGB-RNTI/the MSGA payload transmission or the grant for its C-RNTI or CS-RNTI.
NOTE 4: In case of unaligned SFN across carriers in a cell group, the SFN of the concerned Serving Cell is used to calculate the HARQ Process ID used for configured uplink grants.
NOTE 5: If cg-RetransmissionTimer is not configured, a HARQ process is not shared between different configured grant configurations in the same BWP.
   . . .

### 5.8.2 Uplink

There are two types of transmission without dynamic grant:
configured grant Type 1 where an uplink grant is provided by RRC, and stored as configured uplink grant;
configured grant Type 2 where an uplink grant is provided by PDCCH, and stored or cleared as configured uplink grant based on L1 signalling indicating configured uplink grant activation or deactivation.

Type 1 and Type 2 are configured by RRC per Serving Cell and per BWP. Multiple configurations can be active simultaneously in the same BWP. For Type 2, activation and deactivation are independent among the Serving Cells. For the same BWP, the MAC entity can be configured with both Type 1 and Type 2.

RRC configures the following parameters when the configured grant Type 1 is configured:
cs-RNTI: CS-RNTI for retransmission;
periodicity: periodicity of the configured grant Type 1;
timeDomainOffset: Offset of a resource with respect to SFN=timeReferenceSFN in time domain;
timeDomainAllocation: Allocation of configured uplink grant in time domain which contains startSymbolAndLength (i.e. SLIV in TS 38.214 [7]) or startSymbol (i.e. S in TS 38.214 [7]);
nrofHARQ-Processes: the number of HARQ processes for configured grant;
harq-ProcID-Offset: offset of HARQ process for configured grant for operation with shared spectrum channel access;
harq-ProcID-Offset2: offset of HARQ process for configured grant;
timeReferenceSFN: SFN used for determination of the offset of a resource in time domain. The UE uses the closest SFN with the indicated number preceding the reception of the configured grant configuration.

RRC configures the following parameters when the configured grant Type 2 is configured:
cs-RNTI: CS-RNTI for activation, deactivation, and retransmission;
periodicity: periodicity of the configured grant Type 2;
nrofHARQ-Processes: the number of HARQ processes for configured grant;
harq-ProcID-Offset: offset of HARQ process for configured grant for operation with shared spectrum channel access;
harq-ProcID-Offset2: offset of HARQ process for configured grant.

RRC configures the following parameters when retransmissions on configured uplink grant is configured:
cg-Retransmission Timer: the duration after a configured grant (re)transmission of a HARQ process when the UE shall not autonomously retransmit that HARQ process.

Upon configuration of a configured grant Type 1 for a Serving Cell by upper layers, the MAC entity shall:
1> store the uplink grant provided by upper layers as a configured uplink grant for the indicated Serving Cell;
1> initialise or re-initialise the configured uplink grant to start in the symbol according to timeDomainOffset, timeReferenceSFN, and S (derived from SLIV or provided by startSymbol as specified in TS 38.214 [7]), and to reoccur with periodicity.

After an uplink grant is configured for a configured grant Type 1, the MAC entity shall consider sequentially that the N^{th} (N>=0) uplink grant occurs in the symbol for which:

[(SFN×numberOfSlotsPerFrame×numberOfSymbolsPerSlot)+(slot number in the frame×

numberOfSymbolsPerSlot)+symbol number in the slot]=

(timeReferenceSFN×numberOfSlotsPerFrame×numberOfSymbolsPerSlot+timeDomainOffset×

numberOfSymbolsPerSlot+S+N×periodicity)modulo(1024×numberOfSlotsPerFrame×

numberOfSymbolsPerSlot).

[ . . . ]

When the configured uplink grant is released by upper layers, all the corresponding configurations shall be released and all corresponding uplink grants shall be cleared.

The MAC entity shall:
1> if at least one configured uplink grant confirmation has been triggered and not cancelled; and
1> if the MAC entity has UL resources allocated for new transmission:
   2> if the MAC entity is configured with configuredGrantConfigList:
      3> instruct the Multiplexing and Assembly procedure to generate a Multiple Entry Configured Grant Confirmation MAC CE as defined in clause 6.1.3.31.
   2> else:
      3> instruct the Multiplexing and Assembly procedure to generate a Configured Grant Confirmation MAC CE as defined in clause 6.1.3.7.
   2> cancel the triggered configured uplink grant confirmation.

For a configured grant Type 2, the MAC entity shall clear the configured uplink grant(s) immediately after first transmission of Configured Grant Confirmation MAC CE or Multiple Entry Configured Grant Confirmation MAC CE which confirms the configured uplink grant deactivation.

Retransmissions use:
repetition of configured uplink grants; or
received uplink grants addressed to CS-RNTI; or
configured uplink grants with cg-RetransmissionTimer configured.

In NR, a configuration and a parameter related to a configured Physical Uplink Shared Channel (PUSCH) resource are discussed in one or more parts of 3GPP TS 38.331 V16.1.0 quoted below:

ConfiguredGrantConfig

The IE ConfiguredGrantConfig is used to configure uplink transmission without dynamic grant according to two possible schemes. The actual uplink grant may either be configured via RRC (type1) or provided via the PDCCH (addressed to CS-RNTI) (type2).

ConfiguredGrantConfig information element

| | |
|---|---|
| ConfiguredGrantConfig : := | SEQUENCE { |
| frequencyHopping | ENUMERATED {intraSlot, |
| interSlot} | OPTIONAL, -- Need S |
| cg-DMRS-Configuration | DMRS-UplinkConfig, |
| mcs-Table | ENUMERATED {qam256, |
| qam64LowSE} | OPTIONAL, -- |

Need S

| | |
|---|---|
| mcs-TableTransformPrecoder | ENUMERATED {qam256, |
| qam64LowSE} | OPTIONAL, -- |

Need S

| | |
|---|---|
| uci-OnPUSCH | SetupRelease { CG-UCI-OnPUSCH |
| } | OPTIONAL, -- Need M |
| resourceAllocation | ENUMERATED { |

resourceAllocationType0, resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, |
| s3-0000} | OPTIONAL, -- Need R |
| periodicity | ENUMERATED { |
| | sym2, sym7, sym1x14, |

sym2x14, sym4x14, sym5x14, sym8x14, sym10x14, sym16x14, sym20x14,

sym32x14, sym40x14,

sym64x14, sym80x14, sym128x14, sym160x14, sym256x14, sym320x14,
sym512x14,

sym640x14, sym1024x14,

sym1280x14, sym2560x14, sym5120x14,

sym6, sym1x12,

sym2x12, sym4x12, sym5x12, sym8x12, sym10x12, sym16x12, sym20x12,
sym32x12,

sym40x12, sym64x12,

sym80x12, sym128x12, sym160x12, sym256x12, sym320x12, sym512x12,
sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE } |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SegInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need |

R

| | |
|---|---|
| pathlossReferenceIndex | INTEGER |

```
(0..maxNrofPUSCH-PathlossReferenceRSs-1),
    ...
  }
OPTIONAL, -- Need R
  ...
}
```

ConfiguredGrantConfig field descriptions

configuredGrantTimer
Indicates the initial value of the configured grant timer (see TS
38.321 [3]) in multiples of periodicity.
frequencyDomainAllocation
Indicates the frequency domain resource allocation, see TS 38.214
[19], clause 6.1.2, and TS 38.212 [17], clause 7.3.1).
nrofHARO-Processes
The number of HARQ processes configured. It applies for both
Type 1 and Type 2. See TS 38.321 [3], clause 5.4.1.
periodicity
Periodicity for UL transmission without UL grant for type 1 and
type 2 (see TS 38.321 [3], clause 5.8.2).
The following periodicities are supported depending on the
configured subcarrier spacing
[symbols]:
15 kHz: 2,7, n*14, where n={1, 2, 4, 5, 8, 10, 16, 20, 32, 40, 64,
80, 128, 160, 320, 640}
30 kHz: 2,7, n*14, where n={1, 2, 4, 5, 8, 10, 16, 20, 32, 40, 64,
80, 128, 160, 256, 320, 640, 1280}
60 kHz with normal CP 2, 7, n*14, where n={1, 2, 4, 5, 8, 10, 16,
20, 32, 40, 64, 80, 128, 160, 256, 320, 512, 640, 1280, 2560}
60 kHz with ECP: 2, 6, n*12, where n={1, 2, 4, 5, 8, 10, 16, 20,
32, 40, 64, 80, 128, 160, 256, 320, 512, 640, 1280, 2560}
120 kHz: 2,7, n*14, where n={1, 2, 4, 5, 8, 10, 16, 20, 32, 40, 64,
80, 128, 160, 256, 320, 512, 640, 1024, 1280, 2560, 5120}
repK-RV
The redundancy version (RV) sequence to use. See TS 38.214 [19],
clause 6.1.2. The network configures this field if repetitions are used,
i.e., if repK is set to n2, n4 or n8. Otherwise, the field is absent.
repK
The number of repetitions of K.
resourceAllocation
Configuration of resource allocation type 0 and resource allocation
type 1. For Type 1 UL data transmission without grant,
resourceAllocation should be resourceAllocationType0 or
resourceAllocationType1.
rrc-ConfiguredUplinkGrant
Configuration for ″configured grant″ transmission with fully RRC-
configured UL grant (Type1). If this field is absent the UE uses UL
grant configured by DCI addressed to CS-RNTI (Type2). Type 1
configured grant may be configured for UL or SUL, but not for both
simultaneously.
srs-ResourceIndicator
Indicates the SRS resource to be used.
timeDomainAllocation
Indicates a combination of start symbol and length and PUSCH
mapping type, see TS 38.214 [19], clause 6.1.2 and TS 38.212 [17],
clause 7.3.1.
timeDomainOffset
Offset related to SFN=0, see TS 38.321 [3], clause 5.8.2.
. . .

PhysicalCellGroupConfig

The IE PhysicalCellGroupConfig is used to configure cell-group specific L1 parameters.

PhysicalCellGroupConfig information element

| | |
|---|---|
| PhysicalCellGroupConfig : := | SEQUENCE { |

...

| | |
|---|---|
| sp-CSI-RNTI | RNTI-Value |

OPTIONAL, -- Need R

| | |
|---|---|
| cs-RNTI | SetupRelease { RNTI-Value } |

```
OPTIONAL,  -- Need M
  . . . ,
  [ [
```

| | |
|---|---|
| mcs-C-RNTI | RNTI-Value |

OPTIONAL, -- Need R

| | |
|---|---|
| p-UE-FR1 | P-Max |

OPTIONAL -- Cond MCG-Only
] ] ,

PhysicalCellGroupConfig field descriptions
cs-RNTI

RNTI value for downlink SPS (see SPS-Config) and uplink
configured grant (see ConfiguredGrantConfig).

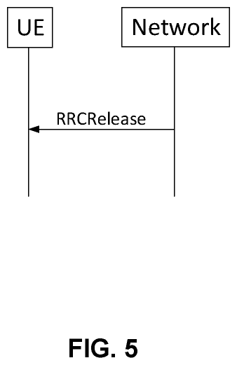

In NR, a description and/or procedure of Radio Resource Control (RRC) release are provided in one or more parts of 3GPP TS 38.331 V16.1.0 quoted below. Notably, FIG. 5.3.8.1-1 of Section 5.3.8.1 of 3GPP TS 38.331 V16.1.0, entitled “RRC connection release, successful”, is reproduced herein as FIG. 5.

### 5.3.8 RRC Connection Release

### 5.3.8.1 General

### FIG. 5.3.8.1-1: RRC Connection Release, Successful

The purpose of this procedure is:
to release the RRC connection, which includes the release of the established radio bearers as well as all radio resources; or
to suspend the RRC connection only if SRB2 and at least one DRB or, for IAB, SRB2, are setup, which includes the suspension of the established radio bearers.

### 5.3.8.2 Initiation

The network initiates the RRC connection release procedure to transit a UE in RRC_CONNECTED to RRC_IDLE; or to transit a UE in RRC_CONNECTED to RRC_INACTIVE only if SRB2 and at least one DRB or, for IAB, SRB2, is setup in RRC_CONNECTED; or to transit a UE in RRC_INACTIVE back to RRC_INACTIVE when the UE tries to resume; or to transit a UE in RRC_INACTIVE to RRC_IDLE when the UE tries to resume. The procedure can also be used to release and redirect a UE to another frequency.

### 5.3.8.3 Reception of the RRCRelease by the UE

The UE shall:
1> delay the following actions defined in this sub-clause 60 ms from the moment the RRCRelease message was received or optionally when lower layers indicate that the receipt of the RRCRelease message has been successfully acknowledged, whichever is earlier;
1> stop timer T380, if running;
1> stop timer T320, if running;
1> if timer T316 is running;
   2> stop timer T316;
   2> clear the information included in VarRLF-Report, if any;
1> stop timer T350, if running;
1> if the AS security is not activated:
   2> ignore any field included in RRCRelease message except waitTime;
   2> perform the actions upon going to RRC_IDLE as specified in 5.3.11 with the release cause ‘other’ upon which the procedure ends;
1> if the RRCRelease message includes redirectedCarrierinfo indicating redirection to eutra:
   2> if cnType is included:
      3> after the cell selection, indicate the available CN Type(s) and the received cnType to upper layers;
NOTE 1: Handling the case if the E-UTRA cell selected after the redirection does not support the core network type specified by the cnType, is up to UE implementation.
   2> if voiceFallbackIndication is included:
      3> consider the RRC connection release was for EPS fallback for IMS voice (see TS 23.502 [43]);
1> if the RRCRelease message includes the cellReselectionPriorities:
   2> store the cell reselection priority information provided by the cellReselectionPriorities;
   2> if the t320 is included:
      3> start timer T320, with the timer value set according to the value of t320;
1> else:
   2> apply the cell reselection priority information broadcast in the system information;
1> if deprioritisationReq is included:
   2> start or restart timer T325 with the timer value set to the deprioritisationTimer signalled;
   2> store the deprioritisationReq until T325 expiry;
1> if the RRCRelease includes the measIdleConfig:
   2> if T331 is running:
      3> stop timer T331;
      3> perform the actions as specified in 5.7.8.3;
   2> if the measIdleConfig is set to setup:
      3> store the received measIdleDuration in VarMeasIdleConfig;
      3> start timer T331 with the value set to measIdleDuration;
      3> if the measIdleConfig contains measldleCarrierListNR:
         4> store the received measldleCarrierListNR in VarMeasIdleConfig;
      3> if the measIdleConfig contains measIdleCarrierListEUTRA:
         4> store the received measIdleCarrierListEUTRA in VarMeasIdleConfig;
      3> if the measIdleConfig contains validi AreaList:
         4> store the received validityAreaList in VarMeasIdleConfig;
1> if the RRCRelease includes suspendConfig:
   2> apply the received suspendConfig;
   2> remove all the entries within VarConditionalReconfig, if any;
   2> for each measId, if the associated reportConfig has a reportType set to condTriggerConfig:
      3> for the associated reportConfigId:
         4> remove the entry with the matching reportConfigId from the reportConfigList within the VarMeasConfig;
      3> if the associated measObjectId is only associated to a reportConfig with reportType set to condTriggerConfig:
         4> remove the entry with the matching measObjectId from the measObjectList within the VarMeasConfig;
      3> remove the entry with the matching measId from the measIdList within the VarMeasConfig;
   2> reset MAC and release the default MAC Cell Group configuration, if any;
   2> re-establish RLC entities for SRB1;
   2> if the RRCRelease message with suspendConfig was received in response to an RRCResumeRequest or an RRCResumeRequest 1:
      3> stop the timer T319 if running;
      3> in the stored UE Inactive AS context:
         4> replace the K_{gNB} and K_{RRcint} keys with the current K_{gNB} and K_{RRCint} keys;
         4> replace the C-RNTI with the temporary C-RNTI in the cell the UE has received the RRCRelease message;
         4> replace the cellIdentity with the cellIdentity of the cell the UE has received the RRCRelease message;
         4> replace the physical cell identity with the physical cell identity of the cell the UE has received the RRCRelease message;
   2> else:
      3> store in the UE Inactive AS Context the current K_{gNB} and K_{RRCint} keys, the ROHC state, the stored QoS flow to DRB mapping rules, the C-RNTI used in the source PCell, the cellIdentity and the physical cell identity of the source PCell, the spCellConfigCommon within ReconfigurationWithSync of the PSCell (if configured) and all other parameters configured except for the ones within ReconfigurationWithSync of the PCell and servingCellConfigCommonSlB;
NOTE 2: NR sidelink communication related configurations and logged measurement configuration are not stored as UE Inactive AS Context, when UE enters RRC_INACTIVE.
   2> suspend all SRB(s) and DRB(s), except SRB0;
   2> indicate PDCP suspend to lower layers of all DRBs;
   2> if the t380 is included:
      3> start timer T380, with the timer value set to t380; 2> if the RRCRelease message is including the waitTime:
      3> start timer T302 with the value set to the waitTime;
      3> inform upper layers that access barring is applicable for all access categories except categories ‘0’ and ‘2’;
   2> if T390 is running:
      3> stop timer T390 for all access categories;
      3> perform the actions as specified in 5.3.14.4;
   2> indicate the suspension of the RRC connection to upper layers;
   2> enter RRC_INACTIVE and perform cell selection as specified in TS 38.304 [20];
1> else
   2> perform the actions upon going to RRC_IDLE as specified in 5.3.11, with the release cause ‘other’.

In NR, small data transmission (SDT) in RRC_INACTIVE state (e.g., Radio Resource Control (RRC) inactive state) may be introduced to transmit and/or receive user data without establishing (and/or resuming) a RRC Connection and subsequently releasing (e.g., release of the RRC Connection), such as discussed in RP-193252 and/or R2-2008124. Transmitting and/or receiving user data in RRC_INACTIVE state via small data transmission may save power (e.g., reduce power consumption) and reduce signaling overhead. To transmit user data in RRC_INACTIVE state, Random Access Channel (RACH)-based and pre-configured PUSCH resources-based methods may be considered, such as discussed in RP-193252. In response to uplink (UL) data (e.g. small data) being available for transmission while the UE is in RRC_INACTIVE state, the UE may initiate a RRC Connection Resume procedure, wherein the RRC Connection Resume procedure may trigger a Random Access (RA) procedure and/or one or more transmissions on one or more pre-configured Physical Uplink Shared Channel (PUSCH) resources. For example, in a scenario in which the UE performs a SDT procedure based on 4-step RA, the UE may transmit a RRC request message (e.g., RRCResumeRequest) and the UL data (e.g., the small data) in Msg3. Alternatively and/or additionally, in a scenario in which the UE performs a small data transmission procedure (SDT procedure) based on 2-step RA, the UE may transmit a RRC request message (e.g., RRCResumeRequest) and the UL data in MSGA. Alternatively and/or additionally, in a scenario in which the UE performs a SDT procedure based on pre-configured PUSCH resources, the UE may transmit a RRC request message (e.g., RRCResumeRequest) and the UL data in a Protocol Data Unit (PDU) transmitted using the pre-configured PUSCH resources. In some examples, the UL data may be multiplexed with the RRC request message (e.g., RRCResumeRequest) in the same Medium Access Control (MAC) PDU. Alternatively and/or additionally, small data transmission without RRC message in RRC_INACTIVE state (e.g., without transmitting a RRC message in RRC_INACTIVE state) may be performed.

In some systems, a SDT procedure comprises a first UL transmission (e.g., a first UL small data transmission) followed by a first downlink (DL) transmission (e.g., a first DL small data transmission). In an example in which the SDT procedure is based on 4-step RA, the UE may transmit UL data (e.g., small data) in Msg3 (e.g., the first UL transmission) and receive a network (NW) response (e.g., a response transmitted by a NW, such as in response to the Msg3 and/or the UL data) in Msg4 (e.g., the first DL transmission). In an example in which the SDT procedure is based on 2-step RA, the UE may transmit UL data in MSGA (e.g., the first UL transmission) and receive a NW response (e.g., a response transmitted by a NW, such as in response to the MSGA and/or the UL data) in MSGB (e.g., the first DL transmission). In an example in which the SDT procedure is based on pre-configured PUSCH resources, the UE may transmit UL data using the pre-configured PUSCH resources (e.g., the first UL transmission) and receive a NW feedback as a response, such as a response to the transmission of the UL data (e.g., the NW feedback may correspond to the first DL transmission). Based on the Work Item description in RP-193252, if there is more data (e.g., UL data and/or DL data available for transmission) that is not (e.g., cannot be) transmitted and/or received within the first UL transmission and/or the first DL transmission, a subsequent transmission (of the more data, for example) and one or more state transition decisions may be under NW control. According to R2-2008124, multiple UL packets and/or DL packets that are part of the SDT mechanism (e.g., subsequent small data transmissions) in RRC_INACTIVE state is supported. If there is more data that is not (e.g., cannot be) transmitted and/or received within the first UL transmission and/or the first DL transmission, the NW may allow and/or configure the UE to transmit (and/or receive) the more data (e.g., subsequent data) when the UE is in RRC_INACTIVE state. Alternatively and/or additionally, if there is more data that is not (e.g., cannot be) transmitted and/or received within the first UL transmission and/or the first DL transmission, the NW may transit (e.g., transition) the UE to RRC_CONNECTED state (e.g., RRC connected state) (and transmit and/or receive the more data when the UE is in RRC_CONNECTED state).

The subsequent small data transmission when the UE is in RRC_INACTIVE state (e.g., transmission of the more data in RRC_INACTIVE state after the first UL transmission and/or the second DL transmission) may enable the UE to avoid transitioning to RRC_CONNECTED state and, thus, may reduce signaling (e.g., signaling overhead) and/or delay. There may be one subsequent UL small data transmission and/or one subsequent DL small data transmission after the first UL small data transmission and/or the first DL small data transmission. Alternatively and/or additionally, there may be multiple subsequent UL small data transmissions and/or multiple subsequent DL small data transmissions after the first UL small data transmission and/or the first DL small data transmission. A RRC release message (e.g., RRCRelease), that is in response to a RRC resume request message (e.g., RRCResumeRequest), may be included in the first DL transmission. Alternatively and/or additionally, the RRC release message (e.g., RRCRelease), that is in response to the RRC resume request message (e.g., RRCResumeRequest), may be included in a last subsequent DL transmission (e.g., a last DL transmission of one or more subsequent DL small data transmissions after the first UL small data transmission and/or the first DL small data transmission). The subsequent small data (e.g., the more data) may be transmitted using the RA mechanism, using one or more configured PUSCH resources (e.g., configured UL grants) and/or using one or more dynamic UL grants. Subsequent small data transmissions (e.g., one or more subsequent UL small data transmissions and/or one or more subsequent DL small data transmissions after the first UL small data transmission and/or the first DL small data transmission) may be considered to be part of the SDT procedure.

After the first UL transmission and/or the first DL transmission (e.g., the first UL small data transmission and/or the first DL small data transmission that are performed via the SDT procedure, such as via RACH-based SDT and/or via pre-configured PUSCH resources-based SDT), one or more subsequent UL transmissions (e.g., one or more subsequent UL small data transmissions) may be performed via one or more configured grants (CGs) when the UE is in RRC_INACTIVE state. To enable subsequent UL transmission via configured grant when the UE is in RRC_INACTIVE state, the NW may provide one or more configured grants for the one or more subsequent UL transmissions (e.g., one or more configured grants for transmission of the subsequent small data). For example, as proposed in R2-2007047, the NW may pre-configure one or more configured PUSCH resources (e.g., the UE may be configured with the one or more configured PUSCH resources) and the NW may activate and/or indicate a configured PUSCH resource of the one or more configured PUSCH resources in the first DL transmission (e.g., Msg4, MSGB), wherein the configured PUSCH resource activated and/or indicated in the first DL transmission may be used for the one or more subsequent UL transmissions. Alternatively and/or additionally, as proposed in R2-2007540, the NW may configure one or more dedicated PUSCH resources (e.g., the UE may be configured with the one or more dedicated PUSCH resources) after receiving the first UL transmission (e.g., Msg3, MSGA), wherein the one or more dedicated PUSCH resources may be used for the one or more subsequent UL transmissions. Alternatively and/or additionally, the NW may provide one or more configured PUSCH resources (to the UE, for example) together with the first DL transmission (e.g., Msg4, MSGB), wherein the one or more configured PUSCH resources may be used for the one or more subsequent UL transmissions. For example, the NW may transmit a transmission, comprising the one or more configured PUSCH resources and the first DL transmission, to the UE (and/or the first DL transmission may comprise the one or more configured PUSCH resources).

The UE may initiate a RRC Connection Resume procedure, when the UE is in RRC_INACTIVE state, to trigger a RA and/or transmit data (e.g., the small data) in Msg3 and/or MSGA. For the subsequent small data (e.g., the more data), the NW may provide one or more configured UL grants in Msg4 and/or MSGB. Alternatively and/or additionally, for the subsequent small data (e.g., the more data), the NW may indicate information in Msg4 and/or MSGB, and may provide the one or more configured UL grants after transmitting Msg4 and/or MSGB.

### Example 1

In Example 1, first data (e.g., data of the first UL small data transmission) may be transmitted in Msg3 and one or more configured resources (e.g., the one or more configured UL grants and/or the one or more configured PUSCH resources) may be provided (to the UE, for example) in Msg4.

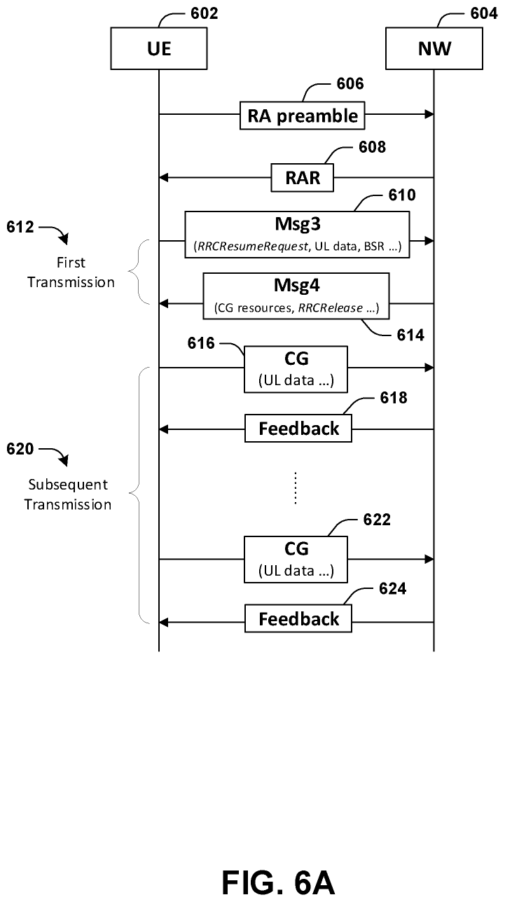

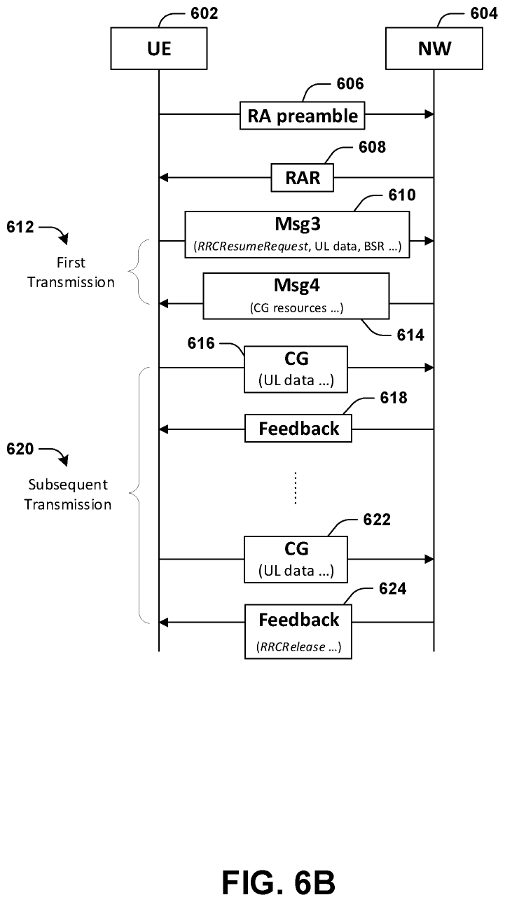

FIGS. 6A-6B illustrate an example scenario of a SDT procedure with subsequent data in which the first data is transmitted in Msg3 (shown with reference number 610) and the one or more configured resources are provided in Msg4 (shown with reference number 614) according to Example 1. The UE (shown with reference number 602) may initiate a RRC Connection Resume procedure to trigger a 4-step RA for the small data transmission in RRC_INACTIVE state. The UE 602 may transmit a RA preamble 606 (e.g., Msg1). The NW (shown with reference number 604) may receive the RA preamble 606 (e.g., Msg1) and transmit a Random Access Response (RAR) 608 (e.g., Msg2). For example, the RAR 608 may be transmitted in response to the RA preamble 606. First transmissions 612 (e.g., the first UL small data transmission and the first DL small data transmission) may be performed. For example, in response to receiving the RAR 608 (e.g., Msg2), the UE 602 may use a UL grant in the RAR 608 (e.g., Msg2) to transmit a Msg3 610 (e.g., the first UL small data transmission), wherein the Msg3 610 may comprise a RRC resume request message (e.g., RRCResumeRequest), user data (e.g., the first data), and/or a Buffer Status Report (BSR). In response to receiving the Msg3 610, the NW 604 may transmit a Msg4 614 (e.g., the first DL small data transmission) to inform (e.g., instruct) the UE 602 to complete the RA procedure. The NW 604 may provide a configuration of the one or more configured resources (e.g., ConfiguredGrantConfig, such as discussed in 3GPP TS 38.331 V16.1.0) in the Msg4 614. The UE 602 may use the one or more configured resources (e.g., the one or more configured PUSCH resources) to transmit the subsequent small data via one or more subsequent transmissions 620. In response to receiving the subsequent small data, the NW 604 may transmit a feedback (e.g., an acknowledgment (ACK) and/or a UL grant for retransmission) to the UE 602. For example, the subsequent small data may be transmitted via a first subsequent small data transmission 616 and/or a second subsequent small data transmission 622. The NW 604 may transmit a first feedback 618 (e.g., an ACK and/or a UL grant for retransmission) in response to the first subsequent small data transmission 616 and/or a second feedback 624 (e.g., an ACK and/or a UL grant for retransmission) in response to the second subsequent small data transmission 622. In FIG. 6A, a RRC release message (e.g., RRCRelease) may be provided to the UE 602 via transmission of Msg4 614 (e.g., the first DL transmission). In FIG. 6B, the RRC release message (e.g., RRCRelease) may be provided to the UE 602 via a last subsequent DL transmission of the one or more subsequent transmissions 620 (e.g., the second feedback 624). In some examples, the RRC release message is transmitted to the UE 602 to keep the UE 602 in RRC_INACTIVE state (e.g., the RRC release message is transmitted to the UE 602 such that the UE 602 stays in RRC_INACTIVE state). For example, the RRC release message may be indicative of staying in RRC_INACTIVE state.

### Example 2

In Example 2, the first data (e.g., data of the first UL small data transmission) may be transmitted in MSGA and the one or more configured resources (e.g., the one or more configured UL grants and/or the one or more configured PUSCH resources) may be provided (to the UE, for example) in MSGB.

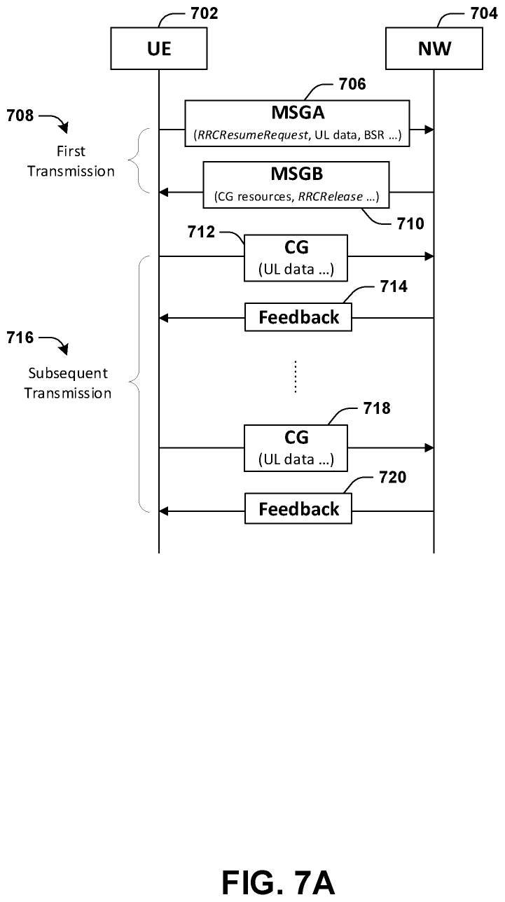

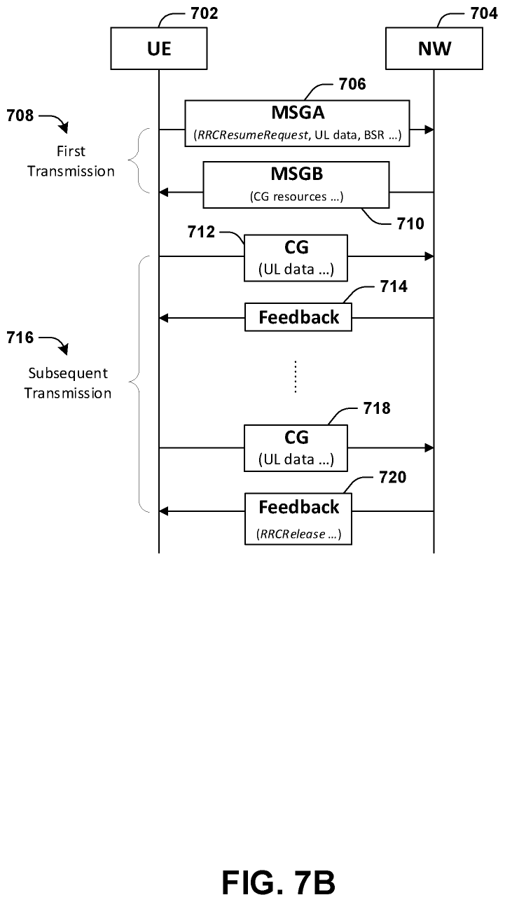

FIGS. 7A-7B illustrate an example scenario of a SDT procedure with subsequent data in which the first data is transmitted in MSGA (shown with reference number 706) and the one or more configured resources are provided in MSGB (shown with reference number 710) according to Example 2. The UE (shown with reference number 702) may initiate a RRC Connection Resume procedure to trigger a 2-step RA for the small data transmission in RRC_INACTIVE state. First transmissions 708 (e.g., the first UL small data transmission and the first DL small data transmission) may be performed. For example, the UE 702 may transmit a MSGA 706 (e.g., the first UL small data transmission) comprising a RA preamble and a PUSCH payload. The PUSCH payload may comprise a RRC resume request message (e.g., RRCResumeRequest), user data (e.g., the first data), and/or a BSR. In response to receiving the MSGA 706, the NW (shown with reference number 704) may transmit a MSGB 710 (e.g., the first DL small data transmission) to inform (e.g., instruct) the UE 702 to complete the RA procedure. The NW 704 may provide a configuration of the one or more configured resources (e.g., ConfiguredGrantConfig, such as discussed in 3GPP TS 38.331 V16.1.0) in the MSGB 710. The UE 702 may use the one or more configured resources (e.g., the one or more configured PUSCH resources) to transmit the subsequent small data via one or more subsequent transmissions 716. In response to receiving the subsequent small data, the NW 704 may transmit a feedback (e.g., an ACK and/or a UL grant for retransmission) to the UE 702. For example, the subsequent small data may be transmitted via a first subsequent small data transmission 712 and/or a second subsequent small data transmission 718. The NW 704 may transmit a first feedback 714 (e.g., an ACK and/or a UL grant for retransmission) in response to the first subsequent small data transmission 712 and/or a second feedback 720 (e.g., an ACK and/or a UL grant for retransmission) in response to the second subsequent small data transmission 718. In FIG. 7A, a RRC release message (e.g., RRCRelease) may be provided to the UE 702 via transmission of MSGB 710 (e.g., the first DL transmission). In FIG. 7B, the RRC release message (e.g., RRCRelease) may be provided to the UE 702 via a last subsequent DL transmission of the one or more subsequent transmissions 716 (e.g., the second feedback 720). In some examples, the RRC release message is transmitted to the UE 702 to keep the UE 702 in RRC_INACTIVE state (e.g., the RRC release message is transmitted to the UE 702 such that the UE 702 stays in RRC_INACTIVE state). For example, the RRC release message may be indicative of staying in RRC_INACTIVE state.

### Example 3

In Example 3, the first data (e.g., data of the first UL small data transmission) may be transmitted in Msg3 and the one or more configured resources (e.g., the one or more configured UL grants and/or the one or more configured PUSCH resources) may be provided (to the UE, for example) after transmission of Msg4.

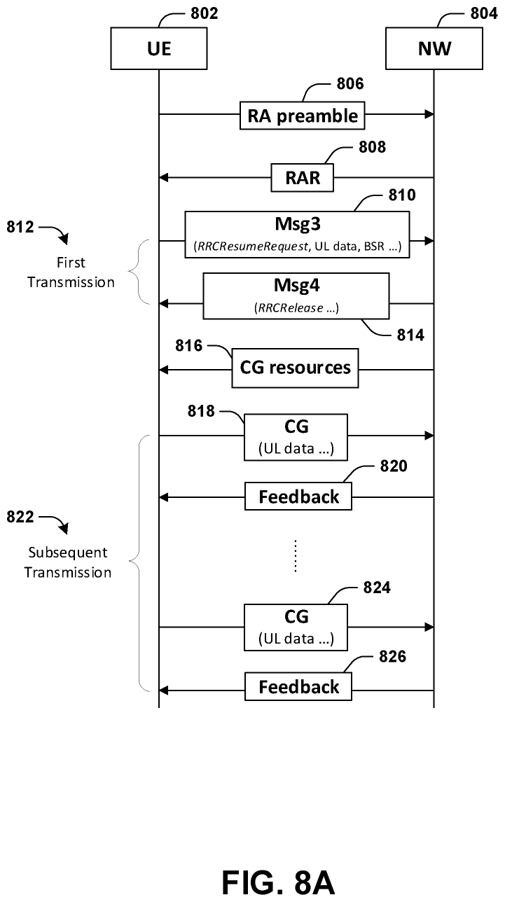

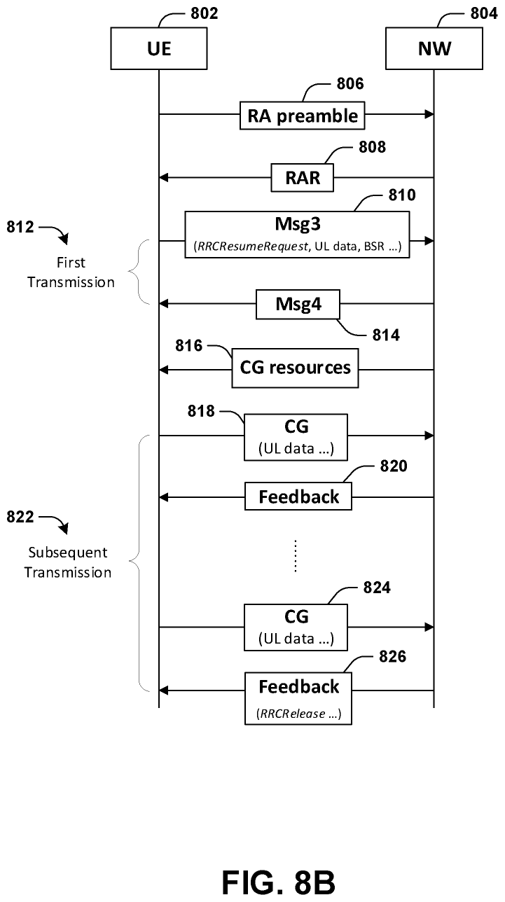

FIGS. 8A-8B illustrate an example scenario of a SDT procedure with subsequent data in which the first data is transmitted in Msg3 (shown with reference number 810) and the one or more configured resources are provided after transmission of Msg4 (shown with reference number 814) according to Example 3. The UE (shown with reference number 802) may initiate a RRC Connection Resume procedure to trigger a 4-step RA for the small data transmission in RRC_INACTIVE state. The UE 802 may transmit a RA preamble 806 (e.g., Msg1). The NW (shown with reference number 804) may receive RA preamble 806 (e.g., Msg1) and transmit a RAR 808 (e.g., Msg2). First transmissions 812 (e.g., the first UL small data transmission and the first DL small data transmission) may be performed. For example, in response to receiving the RAR 808 (e.g., Msg2), the UE 802 may use a UL grant in the RAR 808 (e.g., Msg2) to transmit a Msg3 810 (e.g., the first UL small data transmission), wherein the Msg3 810 may comprise a RRC resume request message (e.g., RRCResumeRequest), user data (e.g., the first data), and/or a BSR. In response to receiving the Msg3 810, the NW 804 may transmit a Msg4 814 (e.g., the first DL small data transmission) to inform (e.g., instruct) the UE 802 to complete the RA procedure and to receive the one or more configured resources (e.g., the one or more configured PUSCH resources). The NW 704 may provide a configuration of the one or more configured resources (e.g., ConfiguredGrantConfig, such as discussed in 3GPP TS 38.331 V16.1.0) after transmitting the Msg4 814. For example, the NW 804 may perform a transmission 816 after transmitting the Msg4 814, wherein the transmission 816 provides the UE 802 with the configuration of the one or more configured resources. The UE 802 may use the one or more configured resources (e.g., the one or more configured PUSCH resources) to transmit the subsequent small data via one or more subsequent transmissions 822. In response to receiving the subsequent small data, the NW 804 may transmit a feedback (e.g., an ACK and/or a UL grant for retransmission) to the UE 802. For example, the subsequent small data may be transmitted via a first subsequent small data transmission 818 and/or a second subsequent small data transmission 824. The NW 804 may transmit a first feedback 820 (e.g., an ACK and/or a UL grant for retransmission) in response to the first subsequent small data transmission 818 and/or a second feedback 826 (e.g., an ACK and/or a UL grant for retransmission) in response to the second subsequent small data transmission 824. In FIG. 8A, a RRC release message (e.g., RRCRelease) may be provided to the UE 802 via transmission of Msg4 814 (e.g., the first DL transmission). In FIG. 8B, the RRC release message (e.g., RRCRelease) may be provided to the UE 802 via a last subsequent DL transmission of the one or more subsequent transmissions 822 (e.g., the second feedback 826). In some examples, the RRC release message is transmitted to the UE 802 to keep the UE 802 in RRC_INACTIVE state (e.g., the RRC release message is transmitted to the UE 802 such that the UE 802 stays in RRC_INACTIVE state). For example, the RRC release message may be indicative of staying in RRC_INACTIVE state.

### Example 4

In Example 4, the first data (e.g., data of the first UL small data transmission) may be transmitted in MSGA and the one or more configured resources (e.g., the one or more configured UL grants and/or the one or more configured PUSCH resources) may be provided (to the UE, for example) after transmission of MSGB.

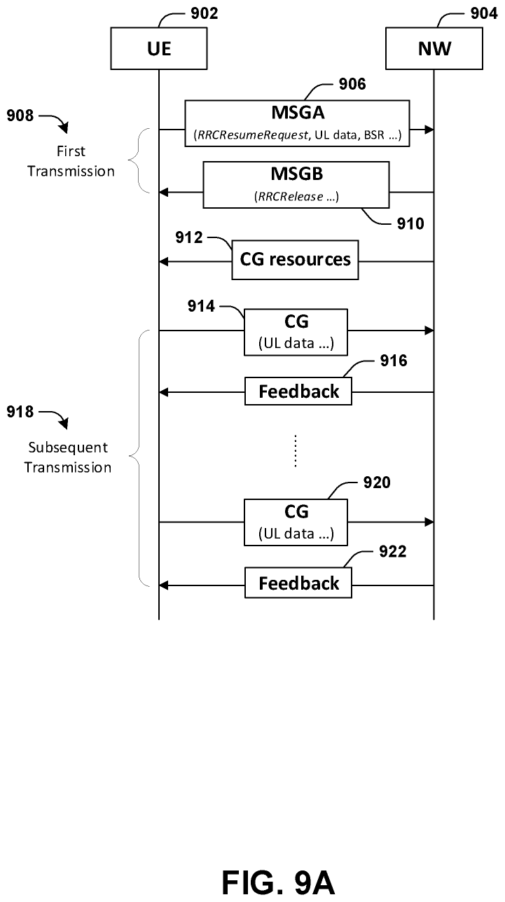

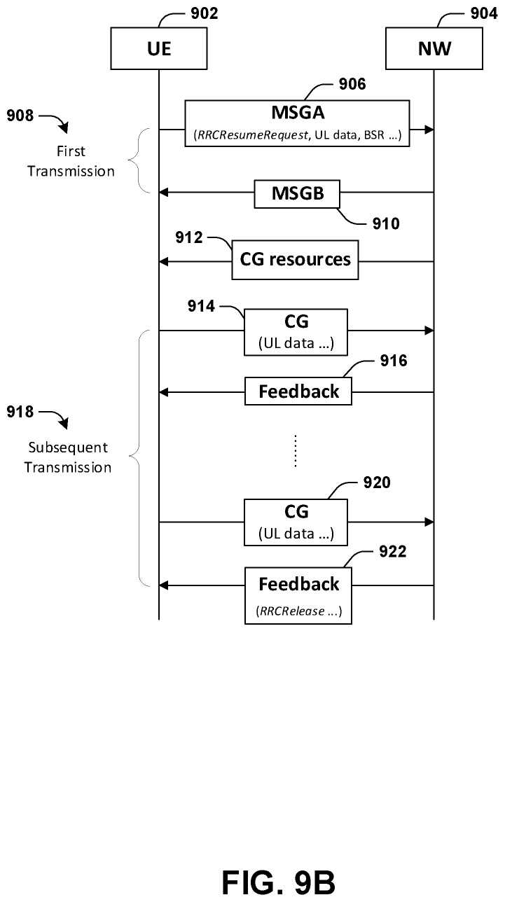

FIGS. 9A-9B illustrate an example scenario of a SDT procedure with subsequent data in which the first data is transmitted in MSGA (shown with reference number 906) and the one or more configured resources are provided after transmission of MSGB (shown with reference number 910) according to Example 4. The UE (shown with reference number 902) may initiate a RRC Connection Resume procedure to trigger a 2-step RA for the small data transmission in RRC_INACTIVE state. First transmissions 908 (e.g., the first UL small data transmission and the first DL small data transmission) may be performed. For example, the UE 902 may transmit a MSGA 906 (e.g., the first UL small data transmission) comprising a RA preamble and a PUSCH payload. The PUSCH payload may comprise a RRC resume request message (e.g., RRCResumeRequest), user data (e.g., the first data), and/or a BSR. In response to receiving the MSGA 906, the NW (shown with reference number 904) may transmit a MSGB (e.g., the first DL small data transmission) to inform (e.g., instruct) the UE 902 to complete the RA procedure and to receive the one or more configured resources (e.g., the one or more configured PUSCH resources). The NW 904 may provide a configuration of the one or more configured resources (e.g., ConfiguredGrantConfig, such as discussed in 3GPP TS 38.331 V16.1.0) after transmitting the MSGB 910. For example, the NW 904 may perform a transmission 912 after transmitting the MSGB 910, wherein the transmission 912 provides the UE 902 with the configuration of the one or more configured resources (e.g., the one or more configured PUSCH resources), such as a configured UL grant. The UE 902 may use the one or more configured resources (such as the configured UL grant) to transmit the subsequent small data via one or more subsequent transmissions 918. In response to receiving the subsequent small data, the NW 904 may transmit a feedback (e.g., an ACK and/or a UL grant for retransmission) to the UE 902. For example, the subsequent small data may be transmitted via a first subsequent small data transmission 914 and/or a second subsequent small data transmission 920. The NW 904 may transmit a first feedback 916 (e.g., an ACK and/or a UL grant for retransmission) in response to the first subsequent small data transmission 914 and/or a second feedback 922 (e.g., an ACK and/or a UL grant for retransmission) in response to the second subsequent small data transmission 920. In FIG. 9A, a RRC release message (e.g., RRCRelease) may be provided to the UE 902 via transmission of MSGB 910 (e.g., the first DL transmission). In FIG. 9B, the RRC release message (e.g., RRCRelease) may be provided to the UE 902 via a last subsequent DL transmission of the one or more subsequent transmissions 918 (e.g., the second feedback 922). In some examples, the RRC release message is transmitted to the UE 902 to keep the UE 902 in RRC_INACTIVE state (e.g., the RRC release message is transmitted to the UE 902 such that the UE 902 stays in RRC_INACTIVE state). For example, the RRC release message may be indicative of staying in RRC_INACTIVE state.

In Examples 1-4, the configuration of the one or more configured resources (e.g., the one or more configured PUSCH resources) may comprise frequency domain resource allocation, time domain resource allocation, and/or periodicity to use (e.g., reuse) the one or more configured resources (e.g., reuse the one or more configured resources periodically according to the periodicity). The one or more subsequent transmissions (e.g., the one or more subsequent transmissions 620, the one or more subsequent transmissions 716, the one or more subsequent transmissions 822, and/or the one or more subsequent transmissions 918) may comprise one UL transmission and/or one DL transmission. Alternatively and/or additionally, the one or more subsequent transmissions (e.g., the one or more subsequent transmissions 620, the one or more subsequent transmissions 716, the one or more subsequent transmissions 822, and/or the one or more subsequent transmissions 918) may comprise multiple UL transmissions and/or multiple DL transmissions. The NW may transmit a RRC release message (e.g., RRCRelease) to keep the UE in the RRC_INACTIVE state.

During the SDT procedure, the UE may monitor Physical Downlink Control Channel (PDCCH) to receive DL transmissions from the NW. For the case of SDT procedure based on 4-step RA, such as shown in FIGS. 6A-6B and 8A-8B, the UE may monitor PDCCH by Random Access Radio Network Temporary Identifier (RA-RNTI) to receive Msg2 and may monitor PDCCH by Temporary Cell Radio Network Temporary Identifier (Temporary C-RNTI) to receive Msg4 (during 4-step RA, for example). For the case of SDT procedure based on 2-step RA, such as shown in FIGS. 7A-7B and 9A-9B, the UE may monitor PDCCH by MSGB Radio Network Temporary Identifier (MSGB-RNTI) to receive MSGB (during 2-step RA, for example). In the NR MAC specification (such as provided in 3GPP TS 38.321 V16.1.0), to perform configured grant transmissions, the UE may need (e.g., may be required) to be configured with Configured Scheduling Radio Network Temporary Identifier (CS-RNTI), and the UE may monitor PDCCH by CS-RNTI (e.g., monitor PDCCH using CS-RNTI) The UE may monitor PDCCH by CS-RNTI to receive activation and/or deactivation (and/or a message indicating activation and/or deactivation) of one or more configured UL grants (e.g., one or more configured UL grants of configured grant Type 1 (CG Type 1) and/or one or more configured UL grants of configured grant Type 2 (CG Type 2)). Alternatively and/or additionally, the UE may monitor PDCCH by CS-RNTI to receive a UL grant for retransmission of a configured UL grant (e.g., a configured UL grant of configured grant Type 1 and/or a configured UL grant of configured grant Type 2), such as for retransmission of a transmission performed using the configured UL grant.

To enable one or more subsequent UL transmissions using one or more configured grants when the UE is in RRC_INACTIVE state (e.g., the one or more subsequent UL transmissions may correspond to one or more UL small data transmissions after a first UL small data transmission and/or a first DL small data transmission), the UE may monitor the PDCCH when the UE is in RRC_INACTIVE state for activation, indication, and/or retransmission (e.g., activation, indication and/or retransmission in RRC_INACTIVE state). In the example scenarios of FIGS. 8A-8B and 9A-9B, the UE may need CS-RNTI (e.g., may be required to be configured with CS-RNTI) to monitor the PDCCH for receiving and/or activating the one or more configured resources (e.g., one or more configured grant resources) when the UE is in RRC_INACTIVE state. In the example scenarios of FIGS. 6A-6B, 7A-7B, 8A-8B and 9A-9B, the UE may need CS-RNTI (e.g., may be required to be configured with CS-RNTI) to monitor the PDCCH for retransmission of the transmitted subsequent data (e.g., the subsequent small data) and/or for deactivating the one or more configured resources (e.g., the one or more configured grant resources) when the UE is in RRC_INACTIVE state.

In a scenario in which a first UL transmission (e.g., a first UL small data transmission) and/or a first DL transmission (e.g., a first DL small data transmission) are performed via pre-configured PUSCH resources-based SDT, the UE may monitor PDCCH by CS-RNTI to receive feedback (e.g., feedback from the NW). The UE may receive the CS-RNTI, when the UE is in RRC_CONNECTED state, in a RRC configuration message. Alternatively and/or additionally, the UE may receive the CS-RNTI (in the RRC release message, for example) when (and/or after) the UE transits (e.g., transitions) and/or releases to RRC_INACTIVE state. Alternatively and/or additionally, the UE may receive the CS-RNTI in the RRC release message (e.g., RRCRelease). However, in a scenario in which a first UL transmission (e.g., a first UL small data transmission) and/or a first DL transmission (e.g., a first DL small data transmission) are performed via RACH-based SDT (e.g., SDT procedure based on 2-step RA and/or SDT procedure based on 4-step RA), the UE may not have a CS-RNTI (e.g., the UE may not have a valid and/or active CS-RNTI), such as a CS-RNTI to monitor on PDCCH when the UE is in RRC_INACTIVE state. In 3GPP TS 38.321 V16.1.0, the CS-RNTI may be configured in a RRC message (e.g., RRC Reconfiguration message) from the NW when the UE is in RRC_CONNECTED state. If the CS-RNTI is configured when the UE is in RRC_CONNECTED state, the CS-RNTI may be released or stored (and the CS-RNTI may not be used, for example) when the UE leaves RRC_CONNECTED state. Accordingly, the UE does not have a CS-RNTI (e.g., a valid and/or active CS-RNTI) when the UE performs the RACH-based SDT in RRC_INACTIVE state. Due to the UE not having a CS-RNTI (e.g., a valid and/or active CS-RNTI) when the UE performs the RACH-based SDT in RRC_INACTIVE state, the UE may not monitor (and/or may not be able to monitor) the PDCCH for the one or more subsequent transmissions using one or more configured grants. Due to the UE not monitoring (and/or not being able to monitor) the PDCCH for the one or more subsequent transmissions using one or more configured grants, the NW may not (and/or may not be able to) recognize the UE by a Radio Network Temporary Identifier (RNTI) and may not (and/or may not be able to) provide a configuration of the one or more configured grants and/or information related to the one or more subsequent transmissions. Techniques and/or methods for the UE to obtain a CS-RNTI (e.g., a valid and/or active CS-RNTI) for PDCCH monitoring for controlling one or more subsequent transmissions (e.g., one or more subsequent transmissions of a SDT procedure after the first UL transmission and/or the first DL transmission of the SDT procedure) using configured grant in RRC_INACTIVE (such as mentioned above) should be considered.

One or more of the techniques provided herein may be used to solve one or more of the aforementioned issues (e.g., the UE not having a CS-RNTI when the UE performs RACH-based SDT in RRC_INACTIVE state and/or the UE not monitoring PDCCH for one or more subsequent transmissions using one or more configured grants).

In a first embodiment, the UE may restore a CS-RNTI in a stored configuration. For example, the stored configuration may be a configuration of the CS-RNTI. The stored configuration may be used by the UE when the UE is in RRC_CONNECTED state. The CS-RNTI may be a CS-RNTI that the UE most recently used when the UE is in RRC_CONNECTED state. In some examples, the CS-RNTI (e.g., the configuration of the CS-RNTI) may be stored (as the stored configuration, for example) when the UE releases and/or transits (e.g., transitions) to RRC_INACTIVE state (e.g., the CS-RNTI may be stored in response to and/or upon the UE releasing and/or transiting to RRC_INACTIVE state). For example, if the CS-RNTI is configured in a cell group configuration (e.g., CellGroupconfig, physicalCellGroupConfig, such as discussed in 3GPP TS 38.331 V16.1.0) from the NW when the UE is in RRC_CONNECTED state, the CS-RNTI may be stored (as the stored configuration, for example) when the UE releases and/or transits (e.g., transitions) to RRC_INACTIVE state (e.g., the CS-RNTI may be stored in response to and/or upon the UE releasing and/or transiting to RRC_INACTIVE state). The UE may restore the CS-RNTI from the stored configuration and/or the UE may reuse the CS-RNTI to monitor PDCCH during one or more subsequent small data transmissions in RRC_INACTIVE state (e.g., one or more subsequent small data transmissions of a SDT procedure after a first UL small data transmission and/or a first DL small data transmission of the SDT procedure). The NW may retrieve the CS-RNTI of the UE and indicate the one or more subsequent transmissions to the UE.

In some examples, the UE may restore and/or reuse the CS-RNTI when the SDT is initiated (e.g., the UE may restore and/or reuse the CS-RNTI in response to and/or upon initiation of the SDT). Alternatively and/or additionally, the UE may restore and/or reuse the CS-RNTI when a first small data transmission (e.g., the first UL small data transmission and/or the first DL small data transmission) is completed (e.g., the UE may restore and/or reuse the CS-RNTI in response to and/or upon completion of the first small data transmission, such as the first UL transmission and/or the first DL transmission). Alternatively and/or additionally, the UE may restore and/or reuse the CS-RNTI when the UE receives a RRC release message (e.g., RRCRelease) to complete the first small data transmission (e.g., the UE may restore and/or reuse the CS-RNTI in response to and/or upon receiving a RRC release message to complete the first small data transmission). Alternatively and/or additionally, the UE may restore and/or reuse the CS-RNTI when the UE receives the first DL transmission (e.g., Msg4, MSGB) (e.g., the UE may restore and/or reuse the CS-RNTI in response to and/or upon receiving the first DL transmission). Alternatively and/or additionally, the UE may restore and/or reuse the CS-RNTI when the UE receives a NW indication (e.g., an indication and/or instruction from the NW) to perform the one or more subsequent transmissions (e.g., the UE may restore and/or reuse the CS-RNTI in response to and/or upon receiving the NW indication). Alternatively and/or additionally, the UE may restore and/or reuse the CS-RNTI when the UE initiates the one or more subsequent transmissions based on pre-configured PUSCH resources (e.g., the UE may restore and/or reuse the CS-RNTI in response to and/or upon initiating the one or more subsequent transmissions based on pre-configured PUSCH resources).

In an example with respect to FIG. 8B, the UE 802 may transmit the RA preamble 806 and may monitor PDCCH by RA-RNTI to receive the RAR 808. In response to receiving the RAR 808, the UE 802 may use a UL grant in the RAR 808 to transmit the Msg3 810 (e.g., the first UL small data transmission). The UE 802 may monitor PDCCH by a Temporary C-RNTI to receive the Msg4 814 (e.g., the first DL small data transmission). The UE 802 may receive an indication for subsequent data transmission in the Msg4 814 (e.g., the Msg4 814 may comprise an indication and/or instruction to perform the one or more subsequent transmissions) and the UE 802 may restore the CS-RNTI from the stored configuration (e.g., the stored configuration stored when the UE 802 releases to RRC_INACTIVE state). After restoring the CS-RNTI, the UE 802 may monitor PDCCH by the restored CS-RNTI to receive the configuration of the one or more configured resources (e.g., one or more configured grant resources), such as a configured UL grant. The UE 802 may use the one or more configured resources (such as the configured UL grant) to transmit a subsequent small data transmission (e.g., the first subsequent small data transmission 818 and/or the second subsequent small data transmission 824). In some examples, the UE 802 may continue monitoring (after transmitting the subsequent small data transmission, for example) PDCCH by the restored CS-RNTI for retransmission and/or deactivation of the subsequent small data transmission.

In some examples, embodiments disclosed herein with respect to the first embodiment may be implemented and/or used to solve one or more of the aforementioned issues (e.g., the UE not having a CS-RNTI when the UE performs RACH-based SDT in RRC_INACTIVE state and/or the UE not monitoring PDCCH for one or more subsequent transmissions using one or more configured grants).

In a second embodiment, the UE may receive a CS-RNTI configured in a RRC message and/or a RRC configuration (e.g., the RRC message and/or the RRC configuration may comprise a configuration of the CS-RNTI and/or the RRC message and/or the RRC configuration may be received from the NW). The UE may receive the CS-RNTI, in a RRC configuration (e.g., a RRC Reconfiguration message), when the UE is in RRC_CONNECTED state. Alternatively and/or additionally, the UE may receive the CS-RNTI in a RRC release message (e.g., RRCRelease). Alternatively and/or additionally, the UE may receive the CS-RNTI in a RRC release message (e.g., RRCRelease) when the UE transits (e.g., transitions) and/or releases to RRC_INACTIVE state from RRC_CONNECTED state. Alternatively and/or additionally, the UE may receive the CS-RNTI in a RRC release message (e.g., RRCRelease) when the UE releases to RRC_INACTIVE state from RRC_INACTIVE state (e.g., the UE stays in RRC_INACTIVE state). In some examples, the UE may receive the CS-RNTI when the UE is in RRC_CONNECTED state. Alternatively and/or additionally, the UE may receive the CS-RNTI when the UE is in RRC_INACTIVE state. In some examples, the CS-RNTI may be configured with one or more configured grant resources. Alternatively and/or additionally, the CS-RNTI may not be configured with one or more configured grant resources.

The UE may apply the CS-RNTI to monitor PDCCH when the CS-RNTI is received (e.g., when a configuration of the CS-RNTI is received) (e.g., the UE may apply the CS-RNTI to monitor PDCCH in response to and/or upon receiving the CS-RNTI, such as receiving the configuration of the CS-RNTI). Alternatively and/or additionally, the UE may apply the CS-RNTI to monitor PDCCH when a first small data transmission is completed (e.g., the UE may apply the CS-RNTI to monitor PDCCH in response to and/or upon completion of the first small data transmission). Alternatively and/or additionally, the UE may apply the CS-RNTI to monitor PDCCH when the UE receives a RRC release message (e.g., RRCRelease) to complete the first small data transmission (e.g., the UE may apply the CS-RNTI to monitor PDCCH in response to and/or upon receiving the RRC release message to complete the first small data transmission). Alternatively and/or additionally, the UE may apply the CS-RNTI to monitor PDCCH when the UE receives the first DL transmission (e.g., Msg4, MSGB) (e.g., the UE may apply the CS-RNTI to monitor PDCCH in response to and/or upon receiving the first DL transmission). Alternatively and/or additionally, the UE may apply the CS-RNTI to monitor PDCCH when the UE receives a NW indication (e.g., an indication and/or instruction from the NW) of the one or more subsequent transmissions (e.g., the UE may apply the CS-RNTI to monitor PDCCH in response to and/or upon receiving the NW indication). Alternatively and/or additionally, the UE may apply the CS-RNTI to monitor PDCCH when the UE initiates the one or more subsequent transmissions using pre-configured PUSCH resources (e.g., the UE may apply the CS-RNTI to monitor PDCCH in response to and/or upon initiating the one or more subsequent transmissions using pre-configured PUSCH resources).

In an example with respect to FIG. 8B, the UE 802 may transmit the RA preamble 806 and may monitor PDCCH by RA-RNTI to receive the RAR 808. In response to receiving the RAR 808, the UE 802 may use a UL grant in the RAR 808 to transmit the Msg3 810 (e.g., the first UL small data transmission). The UE 802 may monitor PDCCH by a Temporary C-RNTI to receive the Msg4 814 (e.g., the first DL small data transmission). The UE 802 may receive the RRC release message (e.g., RRCRelease) comprising the CS-RNTI (e.g., comprising a configuration of the CS-RNTI) in the Msg4 814. After receiving the RRC release message, the UE 802 may monitor PDCCH by the CS-RNTI to receive the configuration of the one or more configured resources (e.g., one or more configured grant resources), such as a configured UL grant. The UE 802 may use the one or more configured resources (such as the configured UL grant) to transmit a subsequent small data transmission (e.g., the first subsequent small data transmission 818 and/or the second subsequent small data transmission 824). In some examples, the UE 802 may continue monitoring (after transmitting the subsequent small data transmission, for example) PDCCH by the CS-RNTI for retransmission and/or deactivation of the subsequent small data transmission.

In some examples, embodiments disclosed herein with respect to the second embodiment may be implemented and/or used to solve one or more of the aforementioned issues (e.g., the UE not having a CS-RNTI when the UE performs RACH-based SDT in RRC_INACTIVE state and/or the UE not monitoring PDCCH for one or more subsequent transmissions using one or more configured grants).

In a third embodiment, the UE may receive a CS-RNTI in a MAC Control Element) and/or a Downlink Control Information (DCI) from the NW. The NW may transmit a MAC CE, comprising (e.g., indicating) the CS-RNTI, to the UE. For example, the MAC CE may be similar to a C-RNTI MAC CE (e.g., the MAC CE may have one or more characteristics matching one or more characteristics of a C-RNTI MAC CE). Alternatively and/or additionally, the NW may transmit a DCI, comprising (e.g., indicating) the CS-RNTI, to the UE. In some examples, the UE may receive the CS-RNTI when the UE is in RRC_CONNECTED state. Alternatively and/or additionally, the UE may receive the CS-RNTI when the UE is in RRC_INACTIVE state. In some examples, the CS-RNTI may be configured with one or more configured grant resources. Alternatively and/or additionally, the CS-RNTI may not be configured with one or more configured grant resources.

In an example with respect to FIG. 8B, the UE 802 may transmit the RA preamble 806 and may monitor PDCCH by RA-RNTI to receive the RAR 808. In response to receiving the RAR 808, the UE 802 may use a UL grant in the RAR 808 to transmit the Msg3 810 (e.g., the first UL small data transmission). The UE 802 may monitor PDCCH by a Temporary C-RNTI to receive the Msg4 814 (e.g., the first DL small data transmission). The UE 802 may receive a MAC CE (e.g., CS-RNTI MAC CE, C-RNTI MAC CE) in the Msg4 814. The UE 802 may determine the CS-RNTI based on the MAC CE in the Msg4 814. For example, the UE may use a RNTI value, indicated by the MAC CE, as the CS-RNTI. After receiving the Msg4 814 (and/or after determining the CS-RNTI), the UE may monitor PDCCH by the CS-RNTI to receive the configuration of the one or more configured resources (e.g., one or more configured grant resources), such as a configured UL grant. The UE 802 may use the one or more configured resources (such as the configured UL grant) to transmit a subsequent small data transmission (e.g., the first subsequent small data transmission 818 and/or the second subsequent small data transmission 824). In some examples, the UE 802 may continue monitoring (after transmitting the subsequent small data transmission, for example) PDCCH by the CS-RNTI for retransmission and/or deactivation of the subsequent small data transmission.

In an example with respect to FIG. 8B, the UE 802 may transmit the RA preamble 806 and may monitor PDCCH by RA-RNTI to receive the RAR 808. In response to receiving the RAR 808, the UE 802 may use a UL grant in the RAR 808 to transmit the Msg3 810 (e.g., the first UL small data transmission). The UE 802 may monitor PDCCH by a Temporary C-RNTI to receive the Msg4 814 (e.g., the first DL small data transmission). The UE 802 may receive a DCI comprising the CS-RNTI. In some examples, the UE 802 may receive the DCI along with the Msg4 814. For example, the UE 802 may receive a transmission of the Msg4 814 and the DCI (e.g., the transmission may comprise the Msg4 814 and the DCI). Alternatively and/or additionally, the Msg4 814 may comprise the DCI. After receiving the DCI and/or the Msg4 814, the UE may monitor PDCCH by the CS-RNTI to receive the configuration of the one or more configured resources (e.g., one or more configured grant resources), such as a configured UL grant. The UE 802 may use the one or more configured resources (such as the configured UL grant) to transmit a subsequent small data transmission (e.g., the first subsequent small data transmission 818 and/or the second subsequent small data transmission 824). In some examples, the UE 802 may continue monitoring (after transmitting the subsequent small data transmission, for example) PDCCH by the CS-RNTI for retransmission and/or deactivation of the subsequent small data transmission.

In some examples, embodiments disclosed herein with respect to the third embodiment may be implemented and/or used to solve one or more of the aforementioned issues (e.g., the UE not having a CS-RNTI when the UE performs RACH-based SDT in RRC_INACTIVE state and/or the UE not monitoring PDCCH for one or more subsequent transmissions using one or more configured grants).

In a fourth embodiment, the UE may determine (e.g., derive and/or calculate) a CS-RNTI based on a C-RNTI that is received by the UE during a RA procedure (e.g., a RA procedure of a SDT procedure performed by the UE). For example, the UE may receive the C-RNTI in the first DL transmission (e.g., Msg4, MSGB), of the RA procedure, from the NW. The UE and the NW may both determine (e.g., derive and/or calculate) the CS-RNTI based on the C-RNTI. For example, the CS-RNTI may be determined (e.g., derived and/or calculated) based on the C-RNTI and one or more predefined rules (e.g., the C-RNTI may be used to derive the CS-RNTI from the one or more predefined rules). In some examples, the C-RNTI may be reused as the CS-RNTI.

In an example with respect to FIG. 8B, the UE 802 may transmit the RA preamble 806 and may monitor PDCCH by RA-RNTI to receive the RAR 808. In response to receiving the RAR 808, the UE 802 may use a UL grant in the RAR 808 to transmit the Msg3 810 (e.g., the first UL small data transmission). The UE 802 may monitor PDCCH by a Temporary C-RNTI to receive the Msg4 814 (e.g., the first DL small data transmission). The UE 802 may receive a C-RNTI in the Msg4 814. For example, the Msg4 814 may comprise the C-RNTI. The UE may use the C-RNTI as an input value to determine (e.g., calculate and/or derive) a CS-RNTI by the one or more predefined rules (e.g., a predefined formula). After receiving the Msg4 814 (and/or after determining the CS-RNTI), the UE 802 may monitor PDCCH by the CS-RNTI to receive the configuration of the one or more configured resources (e.g., one or more configured grant resources), such as a configured UL grant. The UE 802 may use the one or more configured resources (such as the configured UL grant) to transmit a subsequent small data transmission (e.g., the first subsequent small data transmission 818 and/or the second subsequent small data transmission 824). In some examples, the UE 802 may continue monitoring (after transmitting the subsequent small data transmission, for example) PDCCH by the CS-RNTI for retransmission and/or deactivation of the subsequent small data transmission.

In some examples, embodiments disclosed herein with respect to the fourth embodiment may be implemented and/or used to solve one or more of the aforementioned issues (e.g., the UE not having a CS-RNTI when the UE performs RACH-based SDT in RRC_INACTIVE state and/or the UE not monitoring PDCCH for one or more subsequent transmissions using one or more configured grants).

In some examples, a combination of embodiments disclosed herein, such as techniques, embodiments, methods and/or alternatives described with respect to the first embodiment, the second embodiment, the third embodiment and/or the fourth embodiment, may be implemented and/or used, such as to solve one or more of the aforementioned issues (e.g., the UE not having a CS-RNTI when the UE performs RACH-based SDT in RRC_INACTIVE state and/or the UE not monitoring PDCCH for one or more subsequent transmissions using one or more configured grants). For example, techniques, embodiments, methods and/or alternatives described with respect to the first embodiment, the second embodiment, the third embodiment and/or the fourth embodiment may be considered (e.g., jointly considered) (such as for solving one or more of the aforementioned issues).

For example, based on whether or not a RRC message (e.g., a RRC release message) comprises the CS-RNTI (e.g., comprises a configuration of the CS-RNTI), the UE may use the CS-RNTI received in the RRC message (according to the second embodiment, for example) or the UE may restore the CS-RNTI in the stored configuration (according to the first embodiment, for example). For example, the UE may use the CS-RNTI received in the RRC message to monitor PDCCH when the UE is in RRC_INACTIVE if the RRC message comprises the CS-RNTI (e.g., if the RRC message comprises the configuration of the CS-RNTI). Alternatively and/or additionally, if the RRC message does not comprise the CS-RNTI (e.g., if the RRC message does not comprise the configuration of the CS-RNTI), the UE may use the CS-RNTI in the stored configuration to monitor PDCCH when the UE is in RRC_INACTIVE.

In some examples, the UE may trigger a SDT procedure when the UE is in RRC_INACTIVE state. The UE may perform the first UL small data transmission and/or the first DL small data transmission based on RA (e.g., the first UL small data transmission and/or the first DL small data transmission may be performed via a RA procedure of the SDT procedure). The UE may perform the one or more subsequent small data transmissions (e.g., one or more subsequent UL small data transmissions and/or one or more subsequent DL small data transmissions after the first UL small data transmission and/or the first DL small data transmission) based on pre-configured PUSCH resources. Throughout the present disclosure, the term “SDT based on pre-configured PUSCH resources” and/or the term “pre-configured PUSCH resources-based SDT” may correspond to and/or may be replaced by “SDT using configured grant”, “SDT using configured UL grant” and/or “configured grant-based SDT”. The pre-configured PUSCH resources and/or configured grant (e.g., configured UL grant) may be configured grant Type 1 resources. The UE may receive the CS-RNTI (e.g., the configuration of the CS-RNTI) in a RRC message, a RRC configuration, a MAC CE, and/or a DCI. Alternatively and/or additionally, the UE may restore the CS-RNTI in a stored configuration. Alternatively and/or additionally, the UE may determine (e.g., derive and/or calculate) the CS-RNTI based on a received C-RNTI in the first DL small data transmission (e.g., Msg4, MSGB).

In an example, after the first UL small data transmission (e.g., Msg3, MSGA), the UE may receive the configuration of CS-RNTI in a RRC message in the first DL small data transmission (e.g., Msg4, MSGB). If the UE does not receive the configuration of CS-RNTI (in the first DL small data transmission, for example), the UE may restore the CS-RNTI in the stored configuration (e.g., the stored configuration may correspond to a configuration of the CS-RNTI that is used when the UE is in RRC_CONNECTED state) and/or the UE may use the CS-RNTI in the stored configuration for the one or more subsequent small data transmissions. Alternatively and/or additionally, if the UE does not receive the configuration of CS-RNTI, the UE may determine (e.g., calculate and/or derive) the CS-RNTI based on a C-RNTI received in the first DL small data transmission (e.g., Msg4, MSGB) and/or the UE may use the CS-RNTI determined (e.g., calculated and/or derived) based on the C-RNTI for the one or more subsequent small data transmissions. Alternatively and/or additionally, if the UE does not receive the configuration of CS-RNTI and the UE cannot restore the CS-RNTI from a stored configuration, the UE may determine (e.g., calculate and/or derive) the CS-RNTI based on a C-RNTI received in the first DL small data transmission (e.g., Msg4, MSGB).

In an example, the UE may receive the configuration of CS-RNTI in a RRC message (e.g., a RRC release message, such as RRCRelease). For example, the UE may receive the configuration of CS-RNTI in the RRC message when the UE transits (e.g., transitions) to RRC_INACTIVE state from RRC_CONNECTED state. In some examples, if the UE receives the configuration of CS-RNTI in the RRC message, the UE may use the CS-RNTI indicated in the RRC message to monitor PDCCH when the UE is in RRC_INACTIVE. Alternatively and/or additionally, if the UE does not receive the configuration of CS-RNTI in the RRC message, the UE may restore the CS-RNTI in the stored configuration (e.g., the stored configuration may correspond to a configuration of the CS-RNTI that is used when the UE is in RRC_CONNECTED state). For example, the UE may restore the CS-RNTI to be used after the first DL small data transmission (e.g., Msg4, MSGB) (and/or the UE may use the CS-RNTI restored from the stored configuration after the first DL small data transmission). Alternatively and/or additionally, if the UE does not receive the configuration of CS-RNTI in the RRC message, the UE may determine (e.g., calculate and/or derive) the CS-RNTI based on a C-RNTI received in the first DL small data transmission (e.g., Msg4, MSGB). For example, the UE may determine (e.g., calculate and/or derive) the CS-RNTI to be used after the first DL small data transmission (e.g., Msg4, MSGB) (and/or the UE may use the CS-RNTI determined based on the C-RNTI after the first DL small data transmission). Alternatively and/or additionally, if the UE does not receive the configuration of CS-RNTI in the RRC message and the UE cannot restore the CS-RNTI from a stored configuration, the UE may determine (e.g., calculate and/or derive) the CS-RNTI based on the C-RNTI received in the first DL small data transmission (e.g., Msg4, MSGB) (e.g., the UE may determine the CS-RNTI to be used after the first DL small data transmission and/or the UE may use the CS-RNTI determined based on the C-RNTI after the first DL small data transmission).

In an example, the UE may receive the configuration of CS-RNTI in a RRC release message (e.g., RRCRelease). For example, the UE may receive the configuration of CS-RNTI in the RRC release message when the UE transits (e.g., transitions) to RRC_INACTIVE state from RRC_CONNECTED state. In some examples, if the UE does not receive the configuration of CS-RNTI in the RRC release message, the UE may restore and/or reuse the CS-RNTI in the stored configuration (e.g., the stored configuration may correspond to a configuration of the CS-RNTI that is used when the UE is in RRC_CONNECTED state). Alternatively and/or additionally, if the UE receives the configuration of CS-RNTI in the RRC release message, the UE may use the CS-RNTI received in the RRC release message.

In an example, the UE may receive the configuration of CS-RNTI in a RRC release message (e.g., RRCRelease). For example, the UE may receive the configuration of CS-RNTI in the RRC release message when the UE completes a SDT procedure. In some examples, if the UE does not receive the configuration of CS-RNTI in the RRC release message, the UE may restore and/or reuse the CS-RNTI in the stored configuration (e.g., the stored configuration may correspond to a configuration of the CS-RNTI that is used when the UE is in RRC_CONNECTED state), in a second SDT procedure (e.g., a next SDT procedure following completion of the SDT procedure). Alternatively and/or additionally, if the UE receives the configuration of CS-RNTI in the RRC release message, the UE may use the CS-RNTI received in the RRC release message in a second SDT procedure (e.g., a next SDT procedure following completion of the SDT procedure).

In an example, after the first DL small data transmission (e.g., Msg4, MSGB), the UE may restore the CS-RNTI in the stored configuration (e.g., the stored configuration may correspond to a configuration of the CS-RNTI that is used when the UE is in RRC_CONNECTED state). If the UE cannot restore a CS-RNTI (from a stored configuration, for example), the UE may determine (e.g., calculate and/or derive) the CS-RNTI based on a C-RNTI received in the first DL small data transmission (e.g., Msg4, MSGB).

With respect to one or more embodiments herein, such as one or more techniques, devices, concepts, methods and/or alternatives described above, the CS-RNTI may be a RNTI used by the UE to monitor the PDCCH for receiving and/or activating the one or more configured grant resources (for subsequent small data transmission, for example) when the UE is in RRC_INACTIVE state. Alternatively and/or additionally, the CS-RNTI may be a RNTI used by the UE to monitor the PDCCH for retransmission of transmitted subsequent data (e.g., retransmission of a transmission of the one or more subsequent small data transmissions) and/or for deactivating the one or more configured grant resources (for subsequent small data transmission, for example) when the UE is in RRC_INACTIVE state. Alternatively and/or additionally, the CS-RNTI may be different than a RNTI used by the UE, for transmission using a configured grant, when the UE is in RRC_CONNECTED state. In some examples, the CS-RNTI mentioned above may be replaced by another RNTI (e.g., another type of RNTI, other than the CS-RNTI, may be used in place of the CS-RNTI).

With respect to one or more embodiments herein, the UE may receive one or more configurations, related to small data transmission, from the NW. The UE may receive one or more configurations, related to one or more configured PUSCH resources for subsequent small data transmission (e.g., subsequent small data transmission, of a SDT procedure, following first UL small data transmission and/or first DL small data transmission of the SDT procedure), from the NW.

With respect to one or more embodiments herein, the UE may refer to the UE, a MAC entity of the UE and/or a RRC entity of the UE.

With respect to one or more embodiments herein, the UE may be a NR device. Alternatively and/or additionally, the UE may be a NR-light device (such as discussed in RP-193238). Alternatively and/or additionally, the UE may be a reduced capability device (such as discussed in RP-193238). Alternatively and/or additionally, the UE may be a mobile phone. Alternatively and/or additionally, the UE may be a wearable device. Alternatively and/or additionally, the UE may be a sensor. Alternatively and/or additionally, the UE may be a stationary device.

With respect to one or more embodiments herein, the NW may be a NW node. Alternatively and/or additionally, the NW may be a base station. Alternatively and/or additionally, the NW may be an access point. Alternatively and/or additionally, the NW may be an eNB. Alternatively and/or additionally, the NW may be a gNB.

With respect to one or more embodiments herein, the UE initiates a small data transmission if an upper layer (e.g., RRC layer) indicates a small data transmission (e.g., the UE may initiate the small data transmission in response to and/or upon the upper layer indicating the small data transmission). Alternatively and/or additionally, the UE may initiate a small data transmission if the upper layer (e.g., the RRC layer) requests resuming a suspended RRC connection for transmitting small data when the UE is in RRC_INACTIVE state (e.g., the UE may initiate the small data transmission in response to and/or upon the upper layer requesting to resume the suspended RRC connection for transmitting small data when the UE is in RRC_INACTIVE state). Alternatively and/or additionally, the UE may initiate a subsequent small data transmission of a SDT procedure if the UE has a large amount of data to transmit (e.g., an amount of data exceeding a threshold amount of data). Alternatively and/or additionally, the UE may initiate a subsequent small data transmission of a SDT procedure if the UE expects a large amount of data to transmit (e.g., an amount of data exceeding a threshold amount of data). Alternatively and/or additionally, the UE may initiate a subsequent small data transmission of a SDT procedure if the NW allows subsequent small data transmissions (e.g., a subsequent small data transmission following a first UL small data transmission and/or a first DL small data transmission of the SDT procedure). In some examples, UL data (e.g., small data) may be (and/or may comprise) available UL data for transmission (e.g., UL data of the UE that is available for transmission). Alternatively and/or additionally, the UL data (e.g., small data) may comprise a MAC header. Alternatively and/or additionally, the UL data (e.g., small data) may comprise other information (e.g., at least one of one or more MAC CEs, one or more BSRs, one or more Power Headroom Reports (PHRs), etc.) other than the available UL data for transmission and/or the MAC header. In some examples, first UL data (e.g., small data, such as data transmitted in the first UL small data transmission) may comprise the RRC resume request message (e.g., RRCResumeRequest).

In some systems, a SDT procedure comprises a first UL transmission (e.g., a first UL small data transmission), a first DL transmission (e.g., a first DL small data transmission) following the first UL transmission and/or one or more subsequent small data transmissions following the first DL transmission. After the first UL transmission and/or the first DL transmission (e.g., the first UL small data transmission and/or the first DL small data transmission that are performed via RACH-based SDT and/or via pre-configured PUSCH resources-based SDT), one or more subsequent UL transmissions (e.g., one or more subsequent UL small data transmissions of the one or more subsequent small data transmissions) may be performed via one or more dynamic grants (DGs) when the UE is in RRC_INACTIVE state. To enable subsequent UL transmission via dynamic grant when the UE is in RRC_INACTIVE state, the NW may provide one or more dynamic grants for the one or more subsequent UL transmissions (e.g., one or more dynamic grants for transmission of the subsequent small data). For example, the UE may initiate a RRC Connection Resume procedure when the UE is in RRC_INACTIVE state to trigger a RA and/or transmit first data (e.g., first small data) in a Msg3 and/or MSGA (e.g., the first UL transmission). Alternatively and/or additionally, the UE may initiate a RRC Connection Resume procedure when the UE is in RRC_INACTIVE state to trigger one or more transmissions on one or more pre-configured PUSCH resources and to transmit the first data. In some examples, the NW may transmit a RRC release message (e.g., RRCRelease) to complete the RRC Connection Resume procedure in response to receiving the first data. The NW may provide one or more dynamic UL grants for one or more subsequent small data transmission.

### Example 5

In Example 5, the first data (e.g., the first small data) is transmitted in Msg3.

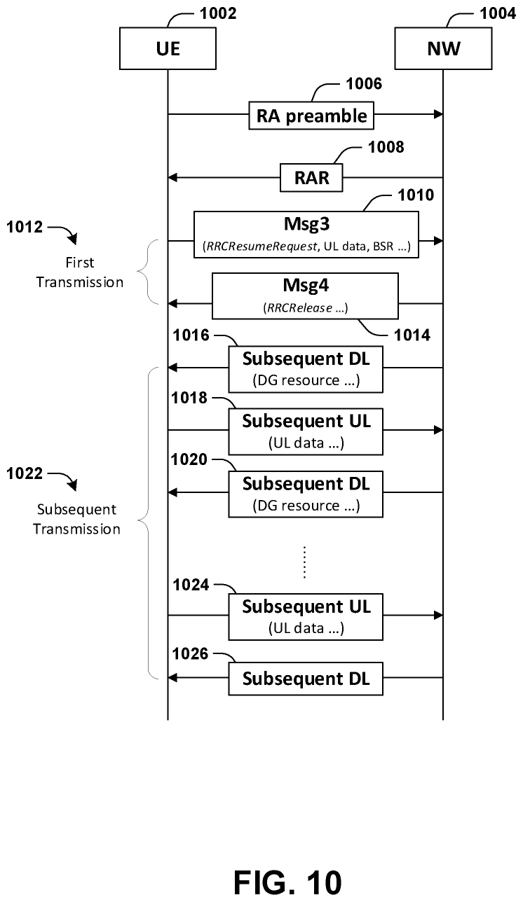

FIG. 10 illustrates an example scenario of a SDT procedure with subsequent data in which the first data is transmitted in Msg3 (shown with reference number 1010). The UE (shown with reference number 1002) may initiate a RRC Connection Resume procedure to trigger a 4-step RA for the small data transmission in RRC_INACTIVE state. The UE 1002 may transmit a RA preamble 1006 (e.g., Msg1). The NW (shown with reference number 1004) may receive the RA preamble 606 (e.g., Msg1) and transmit a RAR 1008 (e.g., Msg2). First transmissions 1012 (e.g., the first UL small data transmission and the first DL small data transmission) may be performed. For example, in response to receiving the RAR 1008 (e.g., Msg2), the UE 1002 may use a UL grant in the RAR 1008 (e.g., Msg2) to transmit a Msg3 1010 (e.g., the first UL small data transmission), wherein the Msg3 1010 may comprise a RRC resume request message (e.g., RRCResumeRequest), user data (e.g., the first data), and/or a BSR. In response to receiving the Msg3 1010, the NW 1004 may transmit a Msg4 1014 (e.g., the first DL small data transmission) to inform (e.g., instruct) the UE 1002 to complete the RA procedure. The NW 1004 may transmit a RRC release message (e.g., RRCRelease) in the Msg4 1014 (e.g., the first DL small data transmission) to complete the RRC Connection Resume procedure (e.g., the RRC release message may be included in the Msg4 1014 and/or the RRC release message may be indicative of completion of the RRC Connection Resume procedure). In some examples, the RRC release message is transmitted to the UE 1002 to keep the UE 1002 in RRC_INACTIVE state (e.g., the RRC release message is transmitted to the UE 1002 such that the UE 1002 stays in RRC_INACTIVE state). For example, the RRC release message may be indicative of staying in RRC_INACTIVE state. The NW 1004 may transmit a first dynamic UL grant to the UE 1002 along with the Msg4 1014. For example, the UE 1002 may receive a transmission of the Msg4 1014 and the first dynamic UL grant (e.g., the transmission may comprise the Msg4 1014 and the first dynamic UL grant). Alternatively and/or additionally, the Msg4 1014 may comprise the first dynamic UL grant. Alternatively and/or additionally, the NW 1004 may transmit the first dynamic UL grant to the UE 1002 after transmitting the Msg4 1014 to the UE 1002. The UE 1002 may use the first dynamic UL grant to transmit the subsequent small data via one or more subsequent transmissions 1022. In response to receiving the subsequent small data, the NW 1004 may transmit a feedback (e.g., an ACK, a UL grant for retransmission and/or a UL grant for another subsequent small data transmission) and/or one or more dynamic UL grants to the UE 1002 (e.g., the feedback may be transmitted via one or more subsequent DL small data transmissions of the one or more subsequent transmissions 1022), wherein the feedback may be transmitted along with the one or more dynamic UL grants (e.g., the one or more dynamic UL grants may be different than the first dynamic UL grant). For example, the one or more subsequent DL small data transmissions may comprise a first subsequent DL transmission 1016, a second subsequent DL transmission 1020 (e.g., a feedback comprising an ACK, a UL grant for retransmission and/or a UL grant for another subsequent small data transmission) and/or a third subsequent DL transmission 1026 (e.g., a feedback comprising an ACK, a UL grant for retransmission and/or a UL grant for another subsequent small data transmission). Alternatively and/or additionally, one or more subsequent UL small data transmissions (of the one or more subsequent transmissions 1022) may comprise a first subsequent UL transmission 1018 and/or a second subsequent UL transmission 1024. In some examples, the subsequent small data may be transmitted via the first subsequent UL transmission 1018 and/or the second subsequent UL transmission 1024. In some examples, the first subsequent UL transmission 1018 may be performed using one or more dynamic UL grants (e.g., the first dynamic UL grant) received via the first subsequent DL transmission 1016. Alternatively and/or additionally, the second subsequent UL transmission 1024 may be performed using one or more dynamic UL grants received via the second subsequent DL transmission 1020 (and/or received via a different transmission other than the second subsequent DL transmission 1020).

### Example 6

In Example 6, the first data (e.g., data of the first UL small data transmission) may be transmitted in MSGA.

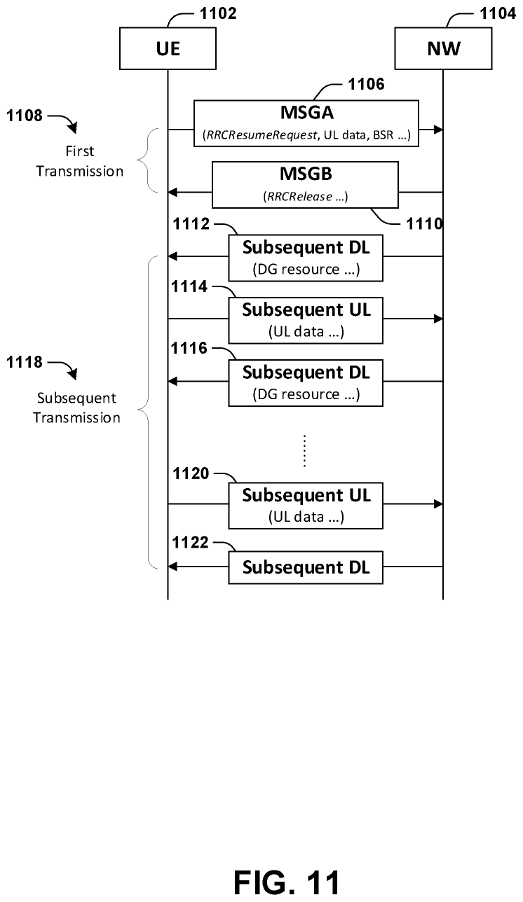

FIG. 11 illustrates an example scenario of a SDT procedure with subsequent data in which the first data is transmitted in MSGA (shown with reference number 1106). The UE (shown with reference number 1102) may initiate a RRC Connection Resume procedure to trigger a 2-step RA for the small data transmission in RRC_INACTIVE state. First transmissions 1108 (e.g., the first UL small data transmission and the first DL small data transmission) may be performed. For example, the UE 1102 may transmit a MSGA 1106 (e.g., the first UL small data transmission) comprising a RA preamble and a PUSCH payload. The PUSCH payload may comprise a RRC resume request message (e.g., RRCResumeRequest), user data (e.g., the first data), and/or a BSR. In response to receiving the MSGA 1106, the NW (shown with reference number 1104) may transmit a MSGB 1110 (e.g., the first DL small data transmission) to inform (e.g., instruct) the UE 1102 to complete the RA procedure. The NW 1104 may transmit a RRC release message (e.g., RRCRelease) in the MSGB 1110 (e.g., the first DL small data transmission) to complete the RRC Connection Resume procedure (e.g., the RRC release message may be included in the MSGB 1110 and/or the RRC release message may be indicative of completion of the RRC Connection Resume procedure). In some examples, the RRC release message is transmitted to the UE 1102 to keep the UE 1102 in RRC_INACTIVE state (e.g., the RRC release message is transmitted to the UE 1102 such that the UE 1102 stays in RRC_INACTIVE state). For example, the RRC release message may be indicative of staying in RRC_INACTIVE state. The NW 1104 may transmit a first dynamic UL grant to the UE 1002 along with the MSGB 1110. For example, the UE 1102 may receive a transmission of the MSGB 1110 and the first dynamic UL grant (e.g., the transmission may comprise the MSGB 1110 and the first dynamic UL grant). Alternatively and/or additionally, the MSGB 1110 may comprise the first dynamic UL grant. Alternatively and/or additionally, the NW 1104 may transmit the first dynamic UL grant to the UE 1102 after transmitting the MSGB 1110 to the UE 1102. The UE 1102 may use the first dynamic UL grant to transmit the subsequent small data via one or more subsequent transmissions 1118. In response to receiving the subsequent small data, the NW 1104 may transmit a feedback (e.g., an ACK, a UL grant for retransmission and/or a UL grant for another subsequent small data transmission) and/or one or more dynamic UL grants to the UE 1102 (e.g., the feedback may be transmitted via one or more subsequent DL small data transmissions of the one or more subsequent transmissions 1118), wherein the feedback may be transmitted along with the one or more dynamic UL grants (e.g., the one or more dynamic UL grants may be different than the first dynamic UL grant). For example, the one or more subsequent DL small data transmissions may comprise a first subsequent DL transmission 1112, a second subsequent DL transmission 1116 (e.g., a feedback comprising an ACK, a UL grant for retransmission and/or a UL grant for another subsequent small data transmission) and/or a third subsequent DL transmission 1122 (e.g., a feedback comprising an ACK, a UL grant for retransmission and/or a UL grant for another subsequent small data transmission). Alternatively and/or additionally, one or more subsequent UL small data transmissions (of the one or more subsequent transmissions 1118) may comprise a first subsequent UL transmission 1114 and/or a second subsequent UL transmission 1120. In some examples, the subsequent small data may be transmitted via the first subsequent UL transmission 1114 and/or the second subsequent UL transmission 1120. In some examples, the first subsequent UL transmission 1114 may be performed using one or more dynamic UL grants (e.g., the first dynamic UL grant) received via the first subsequent DL transmission 1112. Alternatively and/or additionally, the second subsequent UL transmission 1120 may be performed using one or more dynamic UL grants received via the second subsequent DL transmission 1116 (and/or received via a different transmission other than the second subsequent DL transmission 1116).

### Example 7

In Example 7, the first data (e.g., data of the first UL small data transmission) may be transmitted in a PDU using one or more configured PUSCH resources.

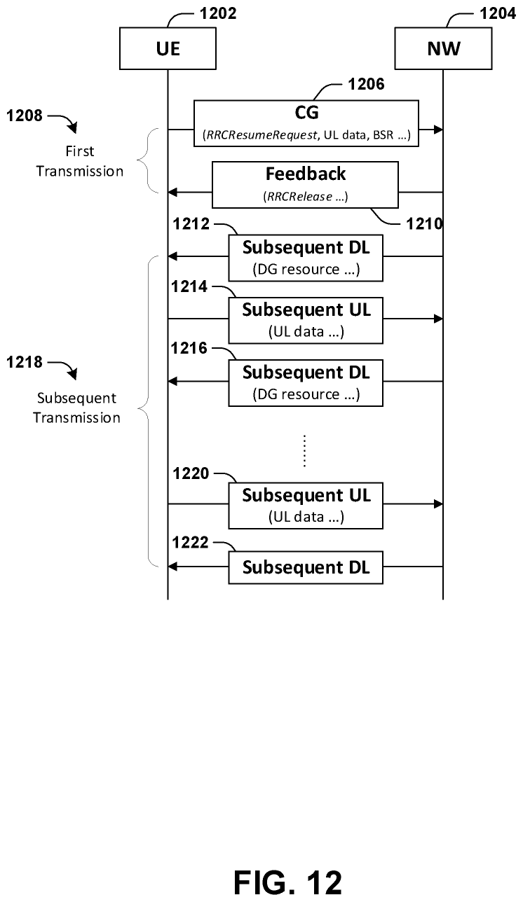

FIG. 12 illustrates an example scenario of a SDT procedure with subsequent data in which the first data is transmitted in a PDU (shown with reference number 1206) using one or more configured PUSCH resources (e.g., the first data is transmitted in a configured grant (CG)). For example, the UE (shown with reference number 1202) may initiate a RRC Connection Resume procedure to trigger one or more transmissions on one or more pre-configured PUSCH resources when the UE is in RRC_INACTIVE state. First transmissions 1208 (e.g., the first UL small data transmission and the first DL small data transmission) may be performed. For example, the UE 1202 may transmit a PDU 1206 (e.g., the first UL small data transmission) using the one or more pre-configured PUSCH resources (e.g., a configured uplink grant), wherein the PDU 1206 may comprise a RRC resume request message (e.g., RRCResumeRequest), user data (e.g., the first data), and/or a BSR. In response to receiving the PDU 1206, the NW (shown with reference number 1204) may transmit a feedback 1210 (e.g., the first DL small data transmission). The NW 1204 may transmit a RRC release message (e.g., RRCRelease) in the feedback 1210 (e.g., the first DL small data transmission) to complete the RRC Connection Resume procedure (e.g., the RRC release message may be included in the feedback 1210 and/or the RRC release message may be indicative of completion of the RRC Connection Resume procedure). In some examples, the RRC release message is transmitted to the UE 1202 to keep the UE 1202 in RRC_INACTIVE state (e.g., the RRC release message is transmitted to the UE 1202 such that the UE 1202 stays in RRC_INACTIVE state). For example, the RRC release message may be indicative of staying in RRC_INACTIVE state. The NW 1204 may transmit a first dynamic UL grant to the UE 1202 along with the feedback 1210. For example, the UE 1202 may receive a transmission of the feedback 1210 and the first dynamic UL grant (e.g., the transmission may comprise the feedback 1210 and the first dynamic UL grant). Alternatively and/or additionally, the feedback 1210 may comprise the first dynamic UL grant. Alternatively and/or additionally, the NW 1204 may transmit the first dynamic UL grant to the UE 1202 after transmitting the feedback 1210 to the UE 1202. The UE 1202 may use the first dynamic UL grant to transmit the subsequent small data via one or more subsequent transmissions 1218. In response to receiving the subsequent small data, the NW 1204 may transmit a second feedback (e.g., an ACK, a UL grant for retransmission and/or a UL grant for another subsequent small data transmission) and/or one or more dynamic UL grants to the UE 1202 (e.g., the second feedback may be transmitted via one or more subsequent DL small data transmissions of the one or more subsequent transmissions 1218), wherein the second feedback may be transmitted along with the one or more dynamic UL grants (e.g., the one or more dynamic UL grants may be different than the first dynamic UL grant). For example, the one or more subsequent DL small data transmissions may comprise a first subsequent DL transmission 1212, a second subsequent DL transmission 1216 (e.g., a feedback comprising an ACK, a UL grant for retransmission and/or a UL grant for another subsequent small data transmission) and/or a third subsequent DL transmission 1222 (e.g., a feedback comprising an ACK, a UL grant for retransmission and/or a UL grant for another subsequent small data transmission). Alternatively and/or additionally, the one or more subsequent UL small data transmissions (of the one or more subsequent transmissions 1218) may comprise a first subsequent UL transmission 1214 and/or a second subsequent UL transmission 1220. In some examples, the subsequent small data may be transmitted via the first subsequent UL transmission 1214 and/or the second subsequent UL transmission 1220. In some examples, the first subsequent UL transmission 1214 may be performed using one or more dynamic UL grants (e.g., the first dynamic UL grant) received via the first subsequent DL transmission 1212. Alternatively and/or additionally, the second subsequent UL transmission 1220 may be performed using one or more dynamic UL grants received via the second subsequent DL transmission 1216 (and/or received via a different transmission other than the second subsequent DL transmission 1216).

In Examples 5-7, the one or more subsequent transmissions (e.g., the one or more subsequent transmissions 1022, the one or more subsequent transmissions 1118 and/or the one or more subsequent transmissions 1218) may comprise one UL transmission and/or one DL transmission. Alternatively and/or additionally, the one or more subsequent transmissions (e.g., the one or more subsequent transmissions 1022, the one or more subsequent transmissions 1118 and/or the one or more subsequent transmissions 1218) may comprise multiple UL transmissions and/or multiple DL transmissions. The NW may transmit a RRC release message (e.g., RRCRelease) to keep the UE in the RRC_INACTIVE state. Feedback (e.g., subsequent DL small data transmissions) transmitted in response to UL data (e.g., subsequent UL small data transmissions) may comprise an ACK, a UL grant for retransmission and/or a UL grant for another subsequent small data transmission.

During the SDT procedure, the UE may monitor PDCCH to receive DL transmissions from the NW. For the case of SDT procedure based on 4-step RA, such as shown in FIG. 10, the UE may monitor PDCCH by RA-RNTI to receive Msg2 and may monitor PDCCH by Temporary C-RNTI to receive Msg4 (during 4-step RA, for example). For the case of SDT procedure based on 2-step RA, such as shown in FIG. 11, the UE may monitor PDCCH by MSGB-RNTI to receive MSGB (during 2-step RA, for example). For the case of SDT procedure based on pre-configured PUSCH resources, such as shown in FIG. 12, the UE may monitor PDCCH by CS-RNTI to receive the feedback (e.g., feedback 1210, such as the first DL small data transmission) for transmission using one or more pre-configured PUSCH resources (e.g., the transmission using one or more pre-configured PUSCH resources may correspond to transmission of the PDU 1206, such as the first UL small data transmission). In the NR MAC specification (such as provided in 3GPP TS 38.321 V16.1.0), to perform dynamic grant transmissions, the UE may need (e.g., may be required) to be configured with C-RNTI, and the UE may monitor PDCCH by C-RNTI.

To enable one or more subsequent UL transmissions using dynamic grants when the UE is in RRC_INACTIVE state (e.g., the one or more subsequent UL transmissions may correspond to one or more UL small data transmissions of a SDT procedure after a first UL small data transmission and/or a first DL small data transmission of the SDT procedure), the UE may need (e.g., may be required) to monitor the PDCCH by C-RNTI to receive one or more UL grants (e.g., one or more dynamic grants) and/or to receive feedback of one or more UL transmissions using dynamic grants (e.g., feedback of the one or more subsequent UL transmissions) when the UE is in RRC_INACTIVE state. In some systems, the C-RNTI is provided by the NW during a RA procedure (e.g., the C-RNTI may be promoted from a Temporary C-RNTI obtained in RAR) and the C-RNTI may be kept in RRC_CONNECTED state (e.g., the UE may maintain and/or apply the C-RNTI when the UE is in RRC_CONNECTED state). In some examples, when (and/or after) the UE receives a RRC release message (e.g., RRCRelease) associated with transit (e.g., transition) and/or release of the UE from RRC_CONNECTED state to RRC_INACTIVE state and/or RRC_IDLE state (e.g., the RRC release message may transit and/or release the UE from RRC_CONNECTED state to RRC_INACTIVE state and/or RRC_IDLE state), the UE may release one or more radio resources comprising the C-RNTI. The UE may store a RRC configuration comprising a CS-RNTI (e.g., the RRC configuration stored by the UE may comprise a configuration of the CS-RNTI). Accordingly, the UE may not have a RNTI (e.g., the UE may not have a valid and/or active RNTI) when the UE performs one or more subsequent small data transmissions in RRC_INACTIVE state. Alternatively and/or additionally, the UE may not have a C-RNTI (e.g., the UE may not have a valid and/or active RNTI) for the one or more subsequent UL transmissions using dynamic grants in RRC_INACTIVE state.

In a scenario in which SDT is triggered by a RACH-based method (e.g., RACH-based SDT), the UE may receive a C-RNTI in a first DL transmission (e.g., a first DL small data transmission, such as Msg4 and/or MSGB). However, when the UE receives the RRC release message (e.g., RRCRelease) in the first DL transmission (e.g., in response to and/or upon the UE receiving the RRC release message in the first DL transmission), the UE may release radio resources (e.g., all radio resources), wherein the radio resources released by the UE comprise the C-RNTI. Alternatively and/or additionally, in a scenario in which the SDT is triggered by pre-configured PUSCH resources-based method (e.g., pre-configured PUSCH resources-based SDT), the UE may not receive a C-RNTI from the NW when the UE is in RRC_INACTIVE state. Due to the UE not receiving a C-RNTI from the NW when the UE is in RRC_INACTIVE state, the UE may not have an RNTI to use for monitoring the PDCCH to receive a dynamic UL grant for one or more subsequent transmissions (e.g., the one or more subsequent UL transmissions). Due to the UE not having an RNTI to use for monitoring the PDCCH to receive a dynamic UL grant for the one or more subsequent transmissions, the NW may not recognize (e.g., may not be able to recognize) the UE by an RNTI and/or the NW may not provide (e.g., may not be able to provide) a dynamic UL grant for the one or more subsequent transmissions. Techniques and/or methods for the UE to obtain a RNTI (e.g., a valid and/or active RNTI) for PDCCH monitoring for controlling one or more subsequent transmissions (e.g., one or more subsequent transmissions of a SDT procedure after a first UL transmission and/or a first DL transmission of the SDT procedure) using dynamic grant in RRC_INACTIVE (such as mentioned above) should be considered.

One or more of the techniques provided herein may be used to solve one or more of the aforementioned issues (e.g., the UE not having an RNTI to use for monitoring the PDCCH to receive a dynamic UL grant for one or more subsequent transmissions, the NW not recognizing the UE by an RNTI and/or the NW not providing a dynamic UL grant for the one or more subsequent transmissions).

In a fifth embodiment, the UE may monitor PDCCH by a first RNTI to receive a dynamic grant (e.g., the dynamic grant may be used for one or more subsequent small data transmissions, such as one or more subsequent small data transmissions after a first UL small data transmission and/or a first DL small data transmission). The first RNTI may be determined (e.g., derived and/or calculated) based on an RNTI (e.g., an existing RNTI) during a first small data transmission (e.g., the first UL small data transmission and/or the first DL small data transmission). For example, the RNTI (e.g., the existing RNTI) may correspond to an RNTI the UE uses for the first small data transmission and/or an RNTI of the UE during the first small data transmission. The UE and the NW may both determine (e.g., derive and/or calculate) the first RNTI (for the one or more subsequent small data transmissions, for example) based on a same rule. The first RNTI may be determined (e.g., derived and/or calculated) based on a RA-RNTI, a MSGB-RNTI, a Temporary C-RNTI, a C-RNTI, a CS-RNTI and/or a RNTI for transmission using pre-configured PUSCH resources of the UE. The UE may determine (e.g., derive and/or calculate) a RA-RNTI and/or a MSGB-RNTI during a small data transmission using RA scheme (e.g., during RACH-based SDT, such as a SDT procedure that is performed using RA scheme). The NW may recognize the RA-RNTI and/or the MSGB-RNTI during the small data transmission using RA scheme (e.g., during the RACH-based SDT, such as the SDT procedure that is performed using RA scheme). The UE may receive, from the NW, a Temporary C-RNTI in RAR during the small data transmission using RA scheme (e.g., during the RACH-based SDT, such as the SDT procedure that is performed using RA scheme). The UE may receive, from the NW, a C-RNTI in the first DL transmission (e.g., in Msg4 and/or MSGB) during the small data transmission using RA scheme. The UE may have a configured RNTI (e.g., CS-RNTI) during a small data transmission using pre-configured resources (e.g., during a pre-configured PUSCH resources-based SDT, such as a SDT procedure that is performed using pre-configured PUSCH resources). One or more RNTIs (e.g., one, some and/or all RNTIs) of the above mentioned RNTIs (e.g., the RA-RNTI, the MSGB-RNTI, the Temporary C-RNTI, the C-RNTI, the CS-RNTI, the RNTI for transmission using pre-configured PUSCH resources of the UE and/or the configured RNTI) may be used to determine (e.g., derive and/or calculate) the first RNTI based on one or more predefined rules (e.g., a predefined formula). Alternatively and/or additionally, one or more RNTIs (e.g., one, some and/or all RNTIs) of the above mentioned RNTIs (e.g., the RA-RNTI, the MSGB-RNTI, the Temporary C-RNTI, the C-RNTI, the CS-RNTI, the RNTI for transmission using pre-configured PUSCH resources of the UE and/or the configured RNTI) may be reused as the first RNTI. In some examples, the first RNTI may be a C-RNTI. The UE may monitor the PDCCH by the first RNTI to receive a dynamic grant (e.g., the dynamic grant may be used for one or more subsequent UL transmissions, such as one or more subsequent UL small data transmissions after the first UL small data transmission and/or the first DL small data transmission).

In some examples, the UE may determine (e.g., derive and/or calculate) the first RNTI when subsequent data transmission (e.g., one or more subsequent small data transmissions after the first UL small data transmission and/or the first DL small data transmission) is requested (e.g., the UE may determine the first RNTI in response to and/or upon the subsequent data transmission being requested). Alternatively and/or additionally, the UE may determine (e.g., derive and/or calculate) the first RNTI when the first small data transmission (e.g., the first UL small data transmission and/or the first DL small data transmission) is completed (e.g., the UE may determine the first RNTI in response to and/or upon completion of the first small data transmission). Alternatively and/or additionally, the UE may determine (e.g., derive and/or calculate) the first RNTI when the UE receives a RRC release message (e.g., RRCRelease) to complete the first small data transmission (e.g., the UE may determine the first RNTI in response to and/or upon receiving a RRC release message to complete the first small data transmission). Alternatively and/or additionally, the UE may determine (e.g., derive and/or calculate) the first RNTI when the UE receives the first DL transmission (e.g., the first DL small data transmission, such as Msg4 and/or MSGB) (e.g., the UE may determine the first RNTI in response to and/or upon receiving the first DL transmission). Alternatively and/or additionally, the UE may determine (e.g., derive and/or calculate) the first RNTI when the UE receives a NW indication (e.g., an indication and/or instruction from the NW) to perform subsequent transmission (e.g., subsequent small data transmission) (e.g., the UE may determine the first RNTI in response to and/or upon receiving the NW indication).

In an example with respect to FIG. 10, the UE 1002 may transmit the RA preamble 1006 and may monitor PDCCH by RA-RNTI to receive the RAR 1008. In response to receiving the RAR 1008, the UE 1002 may use a UL grant in the RAR 1008 to transmit the Msg3 1010 (e.g., the first UL small data transmission). The UE 1002 may monitor PDCCH by a Temporary C-RNTI to receive the Msg4 1014 (e.g., the first DL small data transmission). The UE 1002 may receive a C-RNTI in the Msg4 1014. For example, the Msg4 1014 may comprise the C-RNTI. In some examples, the UE 1002 may use the C-RNTI as an input value to determine (e.g., calculate and/or derive) a first RNTI by the one or more predefined rules (e.g., a predefined formula). Alternatively and/or additionally, the UE 1002 may reuse the C-RNTI (received in the Msg4 1014, for example) as the first RNTI (e.g., the first RNTI may be the same as the C-RNTI). Alternatively and/or additionally, the UE 1002 may receive the RRC release message (e.g., RRCRelease) in the Msg4 1014. For example, the Msg4 1014 may comprise the RRC release message. In some examples, the UE 1002 may release the C-RNTI (in response to the RRC release message, for example). After receiving the RRC release message and/or releasing the C-RNTI, the UE 1002 may monitor PDCCH by the first RNTI to receive one or more dynamic UL grants. The UE 1002 may transmit a subsequent small data transmission (e.g., the first subsequent UL transmission 1018 and/or the second subsequent UL transmission 1024), such as using the one or more dynamic UL grants. In some examples, the UE 1002 may continue monitoring (after transmitting the subsequent small data transmission, for example) PDCCH by the first RNTI for retransmission and/or one or more other UL grants of one or more subsequent transmissions (e.g., one or more subsequent small data transmissions).

In an example with respect to FIG. 12, the UE 1202 may transmit the PDU 1206 (e.g., the first UL small data transmission) using the one or more pre-configured PUSCH resources and may monitor PDCCH by CS-RNTI to receive the feedback 1210 (e.g., the first DL small data transmission). The feedback 1210 may be NW feedback (from the NW 1204). The UE 1202 may receive the feedback 1210 (via monitoring PDCCH by the CS-RNTI, for example). The UE may use the CS-RNTI as an input value to determine (e.g., calculate and/or derive) a first RNTI by the one or more predefined rules (e.g., a predefined formula). Alternatively and/or additionally, the UE 1202 may reuse the CS-RNTI as the first RNTI (e.g., the first RNTI may be the same as the CS-RNTI). Alternatively and/or additionally, the UE 1202 may receive the RRC release message (e.g., RRCRelease) in the feedback 1210. For example, the feedback 1210 may comprise the RRC release message. In some examples, the UE 1202 may store the CS-RNTI (in response to the RRC release message, for example). After receiving the RRC release message and/or storing the CS-RNTI, the UE 1202 may monitor PDCCH by the first RNTI to receive one or more dynamic UL grants. The UE 1202 may transmit a subsequent small data transmission (e.g., the first subsequent UL transmission 1214 and/or the second subsequent UL transmission 1220), such as using the one or more dynamic UL grants. In some examples, the UE 1202 may continue monitoring (after transmitting the subsequent small data transmission, for example) PDCCH by the first RNTI for retransmission and/or one or more other UL grants of one or more subsequent transmissions (e.g., one or more subsequent small data transmissions).

In some examples, embodiments disclosed herein with respect to the fifth embodiment may be implemented and/or used to solve one or more of the aforementioned issues (e.g., the UE not having an RNTI to use for monitoring the PDCCH to receive a dynamic UL grant for one or more subsequent transmissions, the NW not recognizing the UE by an RNTI and/or the NW not providing a dynamic UL grant for the one or more subsequent transmissions).

In a sixth embodiment, the UE may monitor PDCCH by a first RNTI to receive a dynamic grant (e.g., the dynamic grant may be used for one or more subsequent small data transmissions, such as one or more subsequent small data transmissions after a first UL small data transmission and/or a first DL small data transmission). The first RNTI may use (e.g., reuse) an RNTI (e.g., an existing RNTI) that is used in a first small data transmission (e.g., the first UL small data transmission and/or the first DL small data transmission). For example, the UE may use (e.g., reuse) the RNTI (e.g., the existing RNTI) that is used in the first small data transmission as the first RNTI (e.g., the first RNTI may be the same as the RNTI). Alternatively and/or additionally, the first RNTI may be provided (to the UE, for example) during the SDT procedure. Alternatively and/or additionally, the UE may receive and/or maintain the first RNTI during and/or after the first small data transmission (e.g., the first UL small data transmission and/or the first DL small data transmission) and may monitor PDCCH by the first RNTI to receive the dynamic grant (to be used for the one or more subsequent small data transmissions). The UE may not release, discard, replace and/or store the first RNTI during the SDT procedure. The first RNTI may be a C-RNTI, a CS-RNTI and/or an RNTI for transmission using one or more pre-configured PUSCH resources. The first RNTI may be received in the first DL small data transmission (e.g., MSGB, Msg4 and/or NW feedback for transmission using one or more pre-configured PUSCH resource). The first RNTI may be included (e.g., indicated) in the RRC release message (e.g., RRCRelease), a MAC CE, and/or a DCI.

In an example with respect to FIG. 10, the UE 1002 may transmit the RA preamble 1006 and may monitor PDCCH by RA-RNTI to receive the RAR 1008. In response to receiving the RAR 1008, the UE 1002 may use a UL grant in the RAR 1008 to transmit the Msg3 1010 (e.g., the first UL small data transmission). The UE 1002 may monitor PDCCH by a Temporary C-RNTI to receive the Msg4 1014 (e.g., the first DL small data transmission). The UE 1002 may receive a C-RNTI and/or the RRC release message (e.g., RRCRelease) in the Msg4 1014. For example, the Msg4 1014 may comprise the C-RNTI and/or the RRC release message. In some examples, the UE 1002 may perform RRC Release (e.g., RRC Release indicated by the RRC release message) but may not release the C-RNTI (e.g., the UE 1002 may perform the RRC Release without releasing the C-RNTI). The UE 1002 may monitor PDCCH by the C-RNTI to receive one or more dynamic UL grants. The UE 1002 may transmit a subsequent small data transmission (e.g., the first subsequent UL transmission 1018 and/or the second subsequent UL transmission 1024), such as using the one or more dynamic UL grants. In some examples, the UE 1002 may continue monitoring (after transmitting the subsequent small data transmission, for example) PDCCH by the C-RNTI for retransmission and/or one or more other UL grants of one or more subsequent transmissions (e.g., one or more subsequent small data transmissions).

In an example with respect to FIG. 12, the UE 1202 may transmit the PDU 1206 (e.g., the first UL small data transmission) using the one or more pre-configured PUSCH resources and may monitor PDCCH by CS-RNTI to receive the feedback 1210 (e.g., the first DL small data transmission). The feedback 1210 may be NW feedback (from the NW 1204). The UE 1202 may receive the feedback 1210 (via monitoring PDCCH by the CS-RNTI, for example). The feedback 1210 may comprise the RRC release message (e.g., RRCRelease) and a MAC CE of the first RNTI (e.g., a C-RNTI MAC CE). The first RNTI may be a C-RNTI. For example, the first RNTI (e.g., the C-RNTI) may be indicated by the MAC CE (e.g., the C-RNTI MAC CE). In some examples, the UE 1202 may perform RRC Release (e.g., RRC Release indicated by the RRC release message) but may not release the first RNTI (e.g., the UE 1202 may perform the RRC Release without releasing the first RNTI). The UE 1202 may monitor PDCCH by the first RNTI to receive one or more dynamic UL grants. The UE 1002 may transmit a subsequent small data transmission (e.g., the first subsequent UL transmission 1214 and/or the second subsequent UL transmission 1220), such as using the one or more dynamic UL grants. In some examples, the UE 1202 may continue monitoring (after transmitting the subsequent small data transmission, for example) PDCCH by the first RNTI for retransmission and/or one or more other UL grants of one or more subsequent transmissions (e.g., one or more subsequent small data transmissions).

In some examples, embodiments disclosed herein with respect to the sixth embodiment may be implemented and/or used to solve one or more of the aforementioned issues (e.g., the UE not having an RNTI to use for monitoring the PDCCH to receive a dynamic UL grant for one or more subsequent transmissions, the NW not recognizing the UE by an RNTI and/or the NW not providing a dynamic UL grant for the one or more subsequent transmissions).

In some examples, a combination of embodiments disclosed herein, such as techniques, embodiments, methods and/or alternatives described with respect to the fifth embodiment and/or the sixth embodiment, may be implemented and/or used, such as to solve one or more of the aforementioned issues (e.g., the UE not having an RNTI to use for monitoring the PDCCH to receive a dynamic UL grant for one or more subsequent transmissions, the NW not recognizing the UE by an RNTI and/or the NW not providing a dynamic UL grant for the one or more subsequent transmissions). For example, techniques, embodiments, methods and/or alternatives described with respect to the fifth embodiment and/or the sixth embodiment may be considered (e.g., jointly considered) (such as for solving one or more of the aforementioned issues).

For example, the UE may trigger (and/or initiate) a SDT procedure when the UE is in RRC_INACTIVE state. The UE may perform a first UL transmission and/or a second DL transmission (of the SDT procedure, for example) based on RA and/or based on one or more pre-configured PUSCH resources (e.g., the first UL transmission may correspond to a first UL small data transmission of the SDT procedure and/or the first DL transmission may correspond to a first DL small data transmission of the SDT procedure). The UE may perform one or more subsequent transmissions (of the SDT procedure, for example) based on one or more dynamic grants (e.g., the one or more subsequent transmissions may comprise one or more subsequent UL small data transmissions of the SDT procedure and/or one or more subsequent DL small data transmissions of the SDT procedure). The UE may determine (e.g., derive and/or calculate) a first RNTI based on an RNTI (e.g., an existing RNTI) during a first small data transmission (e.g., the first UL small data transmission and/or the first DL small data transmission). For example, the RNTI (e.g., the existing RNTI) may correspond to an RNTI the UE uses for the first small data transmission and/or an RNTI of the UE during the first small data transmission. Alternatively and/or additionally, the UE may maintain a first RNTI that exists and/or is received during and/or after the first small data transmission.

In an example, the UE may receive a C-RNTI MAC CE and the RRC release message (e.g., RRCRelease) in the NW feedback (e.g., the feedback 1210). In some examples, the NW feedback may correspond to feedback of a UL small data transmission (e.g., the first UL small data transmission) performed using one or more pre-configured PUSCH resources. In some examples, the UE may perform RRC Release (e.g., RRC Release indicated by the RRC release message) but may not release the C-RNTI (e.g., the UE may perform the RRC Release without releasing the C-RNTI). Alternatively and/or additionally, if the UE does not receive the C-RNTI (via the NW feedback, for example), the UE may use a RNTI (e.g., a RNTI, such as a CS-RNTI and/or other type of RNTI that is for transmission using one or more pre-configured PUSCH resources, such as the first UL small data transmission and/or the first DL small data transmission) as an input value to determine (e.g., derive and/or calculate) a C-RNTI by a predefined formula (e.g., the C-RNTI may be determined based on the RNTI and/or the predefined formula). The UE may monitor PDCCH by the C-RNTI to receive one or more dynamic UL grants. The UE may transmit a subsequent small data transmission, such as using the one or more dynamic UL grants. In some examples, the UE may continue monitoring (after transmitting the subsequent small data transmission, for example) PDCCH by C-RNTI for retransmission and/or one or more other UL grants of one or more subsequent transmissions (e.g., one or more subsequent small data transmissions).

Throughout the present disclosure, the UE monitoring PDCCH by a RNTI (e.g., a RA-RNTI, a MSGB-RNTI, a Temporary C-RNTI, a C-RNTI, a CS-RNTI or a RNTI for transmission using pre-configured PUSCH resources of the UE) may correspond to and/or be replaced by the UE monitoring the PDCCH using the RNTI (e.g., the RA-RNTI, the MSGB-RNTI, the Temporary C-RNTI, the C-RNTI, the CS-RNTI or the RNTI for transmission using pre-configured PUSCH resources of the UE).

One, some and/or all of the foregoing techniques and/or embodiments can be formed to a new embodiment.

In some examples, embodiments disclosed herein, such as embodiments described with respect to the first embodiment, the second embodiment, the third embodiment, the fourth embodiment, the fifth embodiment and the sixth embodiment, may be implemented independently and/or separately. Alternatively and/or additionally, a combination of embodiments disclosed herein, such as embodiments described with respect to the first embodiment, the second embodiment, the third embodiment, the fourth embodiment, the fifth embodiment and/or the sixth embodiment, may be implemented. Alternatively and/or additionally, a combination of embodiments disclosed herein, such as embodiments described with respect to the first embodiment, the second embodiment, the third embodiment, the fourth embodiment, the fifth embodiment and/or the sixth embodiment, may be implemented concurrently and/or simultaneously.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

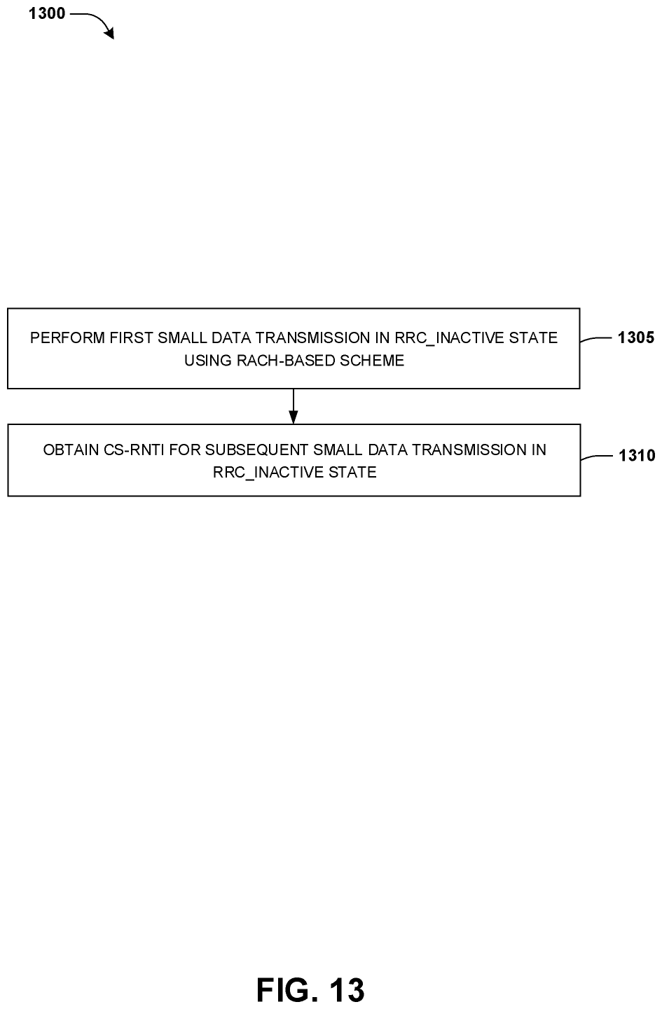

FIG. 13 is a flow chart 1300 according to one exemplary embodiment from the perspective of a UE. In step 1305, the UE performs a first small data transmission, when the UE is in RRC_INACTIVE state, using a RACH-based scheme (e.g., the UE performs the first small data transmission using the RACH-based scheme when the UE is in RRC_INACTIVE state). In step 1310, the UE obtains a CS-RNTI for a subsequent small data transmission when the UE is in RRC_INACTIVE state. For example, the subsequent small data transmission may be after the first small data transmission. Alternatively and/or additionally, the subsequent small data transmission may be performed when the UE is in RRC_INACTIVE state. Alternatively and/or additionally, the UE may obtain the CS-RNTI when the UE is in RRC_INACTIVE state.

In one embodiment, the first small data transmission is a transmission (e.g., a UL transmission) of a SDT procedure (e.g., RACH-based SDT procedure) and/or the subsequent small data transmission is a transmission, of the SDT procedure, that follows the first small data transmission.

In one embodiment, the RACH-based scheme is 4-step RA and/or 2-step RA.

In one embodiment, the first small data transmission comprises a Msg3 transmission and/or a MSGA transmission. For example, first small data of the first small data transmission may be transmitted in the Msg3 and/or the MSGA.

In one embodiment, the UE performs the subsequent small data transmission via one or more pre-configured PUSCH resources. For example, the UE may transmit subsequent small data of the subsequent small data transmission via the one or more pre-configured PUSCH resources.

In one embodiment, the CS-RNTI is restored from a configuration (e.g., a stored configuration). The configuration may be stored (prior to the UE performing the first small data transmission, for example) when the UE enters RRC_INACTIVE state from RRC_CONNECTED state (e.g., in response to the UE entering RRC_INACTIVE state from RRC_CONNECTED state).

In one embodiment, the CS-RNTI is received in a RRC message and/or a RRC configuration. For example, the RRC message and/or the RRC configuration may be received by the UE. Alternatively and/or additionally, the RRC message and/or the RRC configuration may comprise the CS-RNTI.

In one embodiment, the CS-RNTI is received in a MAC CE and/or a DCI. For example, the MAC CE and/or the DCI may be received by the UE. Alternatively and/or additionally, the MAC CE and/or the DCI may comprise the CS-RNTI.

In one embodiment, the CS-RNTI is received in RRC_CONNECTED state (e.g., when the UE is in RRC_CONNECTED state).

In one embodiment, the CS-RNTI is received in RRC_INACTIVE state (e.g., when the UE is in RRC_INACTIVE state.

In one embodiment, the CS-RNTI is determined based on (e.g., derived and/or calculated from) a C-RNTI received in the first small data transmission.

In one embodiment, the UE determines (e.g., derives and/or calculates) the CS-RNTI, based on a predefined rule (e.g., a predefined formula), using the C-RNTI. For example, one or more operations (e.g., mathematical operations) may be performed using the C-RNTI to determine the CS-RNTI (e.g., the one or more operations may be performed in accordance with the predefined rule, such as the predefined formula).

In one embodiment, the UE reuses the C-RNTI as the CS-RNTI (e.g., the CS-RNTI may be the same as the C-RNTI).

In one embodiment, the UE monitors PDCCH by the CS-RNTI to receive one or more pre-configured PUSCH resources for the subsequent small data transmission and/or for one or more subsequent small data transmissions other than the subsequent small data transmission. For example, the UE may use the one or more pre-configured PUSCH resources to perform the subsequent small data transmission and/or the one or more subsequent small data transmissions other than the subsequent small data transmission.

In one embodiment, the UE monitors PDCCH by the CS-RNTI for activation and/or indication for the subsequent small data transmission and/or for activation and/or indication for one or more subsequent small data transmissions other than the subsequent small data transmission.

In one embodiment, the UE monitors PDCCH by CS-RNTI for retransmission and/or deactivation for the subsequent small data transmission and/or for retransmission and/or deactivation for one or more subsequent small data transmissions other than the subsequent small data transmission.

In one embodiment, the UE initiates a RA procedure to transmit first small data (of the first small data transmission, for example) if an upper layer (e.g., RRC layer) indicates a small data transmission (e.g., if the upper layer instructs performing the small data transmission).

In one embodiment, the UE initiates a RA procedure to transmit first small data (of the first small data transmission, for example) if an upper layer (e.g., RRC layer) requests the resume of a suspended RRC connection for small data transmission in RRC_INACTIVE state (e.g., if the upper layer requests resuming the suspended RRC connection for the small data transmission when the UE is in RRC_INACTIVE state).

In one embodiment, the UE initiates the subsequent small data transmission (and/or one or more other subsequent small data transmissions) using one or more pre-configured PUSCH resources if the UE has a large amount of data to transmit (e.g., if an amount of data that is available for transmission by the UE exceeds a threshold amount of data).

In one embodiment, the UE initiates the subsequent small data transmission (and/or one or more other subsequent small data transmissions) using one or more pre-configured PUSCH resources if the UE expects to have a large amount of data to transmit (e.g., if an amount of data that the UE expects to have available for transmission exceeds a threshold amount of data), such as if the UE expects to have the large amount of data (e.g., an amount of data exceeding the threshold amount of data) available for transmission via the first small data transmission and/or the subsequent small data transmission.

In one embodiment, the UE initiates the subsequent small data transmission (and/or one or more other subsequent small data transmissions) using one or more pre-configured PUSCH resources if a NW allows subsequent small data transmission (e.g., if the NW allows and/or configures the UE to perform subsequent small data transmission in a SDT procedure after the first small data transmission of the SDT procedure).

In one embodiment, the UE initiates the subsequent small data transmission (and/or one or more other subsequent small data transmissions) using one or more pre-configured PUSCH resources if a NW provides the UE with a configuration related to pre-configured PUSCH resources (e.g., a configuration of the one or more pre-configured PUSCH resources).

Referring back to FIGS. 3 and 4, in one exemplary embodiment of a UE, the device 300 includes a program code 312 stored in the memory 310. The CPU 308 may execute program code 312 to enable the UE (i) to perform a first small data transmission, when the UE is in RRC_INACTIVE state, using a RACH-based scheme, and (ii) to obtain a CS-RNTI for a subsequent small data transmission when the UE is in RRC_INACTIVE state. Furthermore, the CPU 308 can execute the program code 312 to perform one, some and/or all of the above-described actions and steps and/or others described herein.

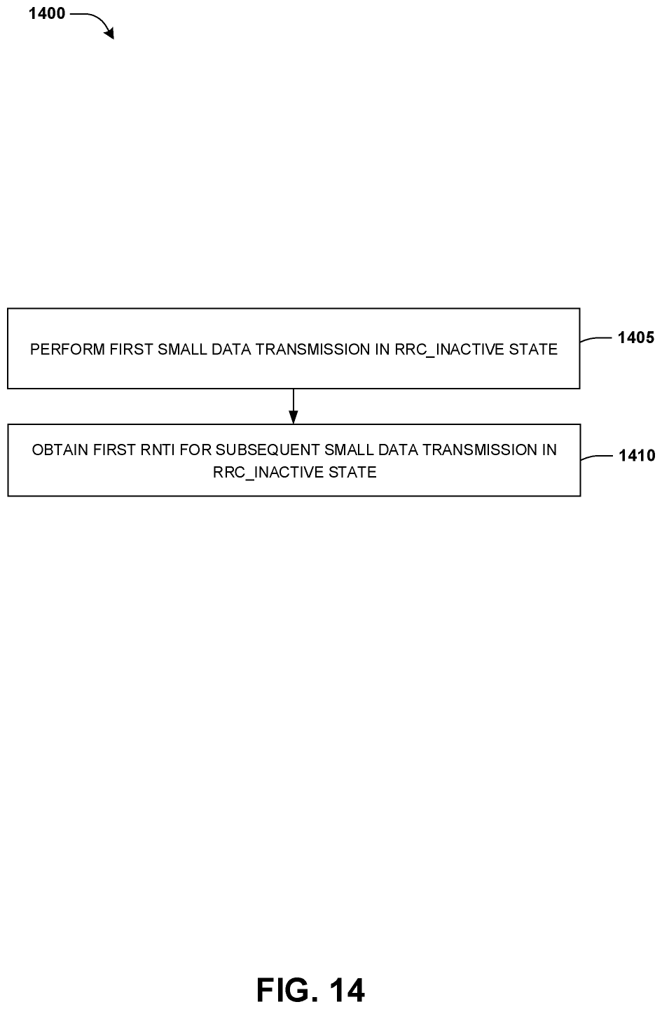

FIG. 14 is a flow chart 1400 according to one exemplary embodiment from the perspective of a UE. In step 1405, the UE performs a first small data transmission when the UE is in RRC_INACTIVE state. In step 1410, the UE obtains a first RNTI for a subsequent small data transmission when the UE is in RRC_INACTIVE state. For example, the subsequent small data transmission may be after the first small data transmission. Alternatively and/or additionally, the subsequent small data transmission may be performed when the UE is in RRC_INACTIVE state. Alternatively and/or additionally, the UE may obtain the first RNTI when the UE is in RRC_INACTIVE state.

In one embodiment, the first small data transmission is a transmission (e.g., a UL transmission) of a SDT procedure (e.g., pre-configured PUSCH resources-based SDT procedure) and/or the subsequent small data transmission is a transmission, of the SDT procedure, that follows the first small data transmission.

In one embodiment, the UE performs the first small data transmission using a RACH-based scheme.

In one embodiment, the RACH-based scheme is 4-step RA and/or 2-step RA.

In one embodiment, the first small data transmission comprises a Msg3 transmission and/or a MSGA transmission. For example, first small data of the first small data transmission may be transmitted in the Msg3 and/or the MSGA.

In one embodiment, the UE performs the first small data transmission using a pre-configured PUSCH resources-based scheme.

In one embodiment, the first small data transmission comprises a transmission of a PDU using one or more pre-configured PUSCH resources. For example, first small data of the first small data transmission may be transmitted in the PDU using the one or more pre-configured PUSCH resources.

In one embodiment, the UE transmits a RRC resume request message (e.g., RRCResumeRequest) along with first small data of the first small data transmission. For example, the first small data transmission may comprise transmission of the first small data and the RRC resume request message.

In one embodiment, the UE receives a RRC release message (e.g., RRCRelease) after the first small data transmission is performed (e.g., after first small data of the first small data transmission is transmitted).

In one embodiment, the UE performs the subsequent small data transmission via one or more dynamic UL grants. For example, the UE may transmit subsequent small data of the subsequent small data transmission in the one or more dynamic UL grants.

In one embodiment, the first RNTI is determined based on (e.g., derived and/or calculated from) an RNTI (e.g., an existing RNTI) during the first small data transmission. For example, the RNTI (e.g., the existing RNTI) may correspond to an RNTI the UE uses for the first small data transmission and/or an RNTI of the UE during the first small data transmission.

In one embodiment, the UE determines (e.g., derives and/or calculates) the first RNTI based on a predefined rule (e.g., a predefined formula), using an RNTI (e.g., an existing RNTI). For example, one or more operations (e.g., mathematical operations) may be performed using the RNTI (e.g., the existing RNTI) to determine the first RNTI (e.g., the one or more operations may be performed in accordance with the predefined rule, such as the predefined formula). For example, the RNTI (e.g., the existing RNTI) may correspond to an RNTI the UE uses for the first small data transmission and/or an RNTI of the UE during the first small data transmission.

In one embodiment, the UE reuses an RNTI (e.g., an existing RNTI) as the first RNTI. For example, the RNTI (e.g., the existing RNTI) may correspond to an RNTI the UE uses for the first small data transmission and/or an RNTI of the UE during the first small data transmission.

In one embodiment, the first RNTI is maintained during one or more small data transmissions (e.g., the first small data transmission and/or one or more subsequent small data transmissions).

In one embodiment, the first RNTI is maintained during a SDT procedure comprising the first small data transmission and/or the subsequent small data transmission.

In one embodiment, the UE does not release, discard and/or replace the first RNTI during the SDT procedure.

In one embodiment, the UE receives the first RNTI during the SDT procedure.

In one embodiment, the UE uses (e.g., reuses) an RNTI (e.g., an existing RNTI), that is used in the first small data transmission, as the first RNTI.

In one embodiment, the existing RNTI (e.g., the first RNTI) is a RA-RNTI, a MSGB-RNTI, a Temporary C-RNTI and/or a C-RNTI during the first small data transmission, wherein the first small data transmission is performed using a RACH-based scheme. For example, the existing RNTI (e.g., the first RNTI) may be a RNTI (e.g., the RA-RNTI, the MSGB-RNTI, the Temporary C-RNTI and/or the C-RNTI), of the UE, during the first small data transmission.

In one embodiment, the existing RNTI (e.g., the first RNTI) is a second RNTI for the first small data transmission, wherein the first small data transmission is performed using a pre-configured PUSCH resources-based scheme.

In one embodiment, the first RNTI is a C-RNTI.

In one embodiment, the first RNTI is a second RNTI for the first small data transmission, wherein the first small data transmission is performed using a pre-configured PUSCH resources-based scheme.

In one embodiment, the second RNTI is a CS-RNTI.

In one embodiment, the first RNTI is received and/or included in a MSGB, a Msg4, and/or a NW feedback. For example, the MSGB, the Msg4, and/or the NW feedback may be received by the UE. Alternatively and/or additionally, the MSGB, the Msg4, and/or the NW feedback may comprise the first RNTI.

In one embodiment, the first RNTI is comprised in a RRC message, a MAC CE and/or a DCI. For example, the UE may receive the RRC message, the MAC CE and/or the DCI.

In one embodiment, the UE monitors PDCCH by the first RNTI to receive one or more dynamic UL grants for the subsequent small data transmission and/or for one or more subsequent small data transmissions other than the subsequent small data transmission. For example, the UE may use the one or more dynamic UL grants to perform the subsequent small data transmission and/or the one or more subsequent small data transmissions other than the subsequent small data transmission.

In one embodiment, the UE monitors PDCCH by the first RNTI for retransmission of the subsequent small data transmission and/or for retransmission of one or more subsequent small data transmissions other than the subsequent small data transmissions.

In one embodiment, the UE initiates a small data transmission (comprising the first small data transmission and/or the subsequent small data transmission, for example) if an upper layer (e.g., RRC layer) indicates a small data transmission (e.g., if the upper layer instructs performing the small data transmission).

In one embodiment, the UE initiates a small data transmission (comprising the first small data transmission and/or the subsequent small data transmission, for example) if an upper layer (e.g., RRC layer) requests the resume of a suspended RRC connection for transmitting small data in RRC_INACTIVE state (e.g., if the upper layer requests resuming the suspended RRC connection for transmitting the small data when the UE is in RRC_INACTIVE state).

In one embodiment, the UE initiates the subsequent small data transmission (and/or one or more other subsequent small data transmissions) if the UE has a large amount of data to transmit (e.g., if an amount of data that is available for transmission by the UE exceeds a threshold amount of data).

In one embodiment, the UE initiates the subsequent small data transmission (and/or one or more other subsequent small data transmissions) if the UE expects to have a large amount of data to transmit (e.g., if an amount of data that the UE expects to have available for transmission exceeds a threshold amount of data), such as if the UE expects to have the large amount of data (e.g., an amount of data exceeding the threshold amount of data) available for transmission via the first small data transmission and/or the subsequent small data transmission.

In one embodiment, the UE initiates the subsequent small data transmission (and/or one or more other subsequent small data transmissions) if a NW allows subsequent small data transmission (e.g., if the NW allows and/or configures the UE to perform subsequent small data transmission in a SDT procedure after the first small data transmission of the SDT procedure).

Referring back to FIGS. 3 and 4, in one exemplary embodiment of a UE, the device 300 includes a program code 312 stored in the memory 310. The CPU 308 may execute program code 312 to enable the UE (i) to perform a first small data transmission when the UE is in RRC_INACTIVE state, and (ii) to obtain a first RNTI for a subsequent small data transmission when the UE is in RRC_INACTIVE state. Furthermore, the CPU 308 can execute the program code 312 to perform one, some and/or all of the above-described actions and steps and/or others described herein.

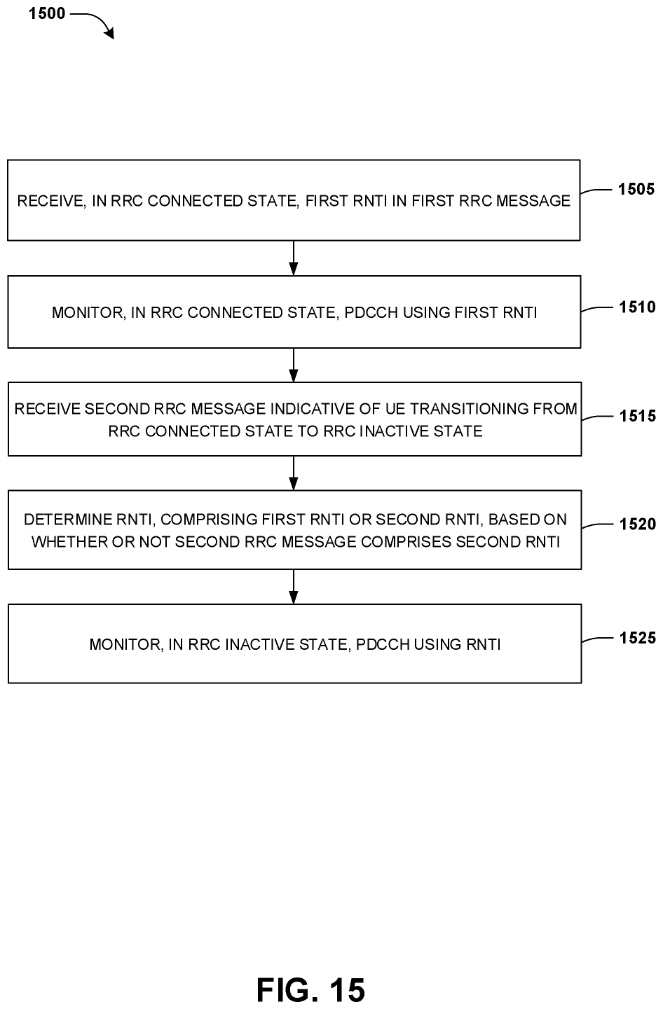

FIG. 15 is a flow chart 1500 according to one exemplary embodiment from the perspective of a UE. In step 1505, the UE receives, when the UE is in RRC connected state (e.g., RRC_CONNECTED state), a first RNTI in a first RRC message. For example, the first RRC message comprises the first RNTI. In step 1510, the UE monitors, when the UE is in RRC connected state, a PDCCH using the first RNTI. For example, when the UE is in RRC connected state, the UE may use the first RNTI to monitor the PDCCH. In step 1515, the UE receives a second RRC message indicative of the UE transitioning (e.g., transiting) from RRC connected state to RRC inactive state. For example, the second RRC message may be transmitted to the UE (by a NW, for example) to transition (e.g., transit) the UE to RRC_INACTIVE state. In step 1520, the UE determines an RNTI, comprising the first RNTI or a second RNTI, based on whether or not the second RRC message comprises the second RNTI. In step 1525, the UE monitors, when the UE is in RRC inactive state, the PDCCH using the RNTI. In an example, the first RNTI may be determined as the RNTI (and the UE may use the first RNTI to monitor the PDCCH when the UE is in RRC inactive state) based on the second RRC message not comprising the second RNTI. Alternatively and/or additionally, the second RNTI may be determined as the RNTI (and the UE may use the second RNTI to monitor the PDCCH when the UE is in RRC inactive state) based on the second RRC message comprising the second RNTI.

In one embodiment, the UE monitors the PDCCH, when the UE is in RRC connected state, to receive an indication of retransmission of a first transmission (e.g., a first transmission, using one or more first configured grants, when the UE is in RRC connected state, wherein the one or more first configured grants may comprise one or more configured grant Type 1 configured grants and/or one or more configured grant Type 2 configured grants). For example, the UE monitors the PDCCH using the first RNTI to receive the indication of retransmission of the first transmission.

In one embodiment, the UE monitors the PDCCH, when the UE is in RRC connected state, to receive an indication of activation of a second transmission (e.g., a second transmission, using one or more second configured grants, when the UE is in RRC connected state, wherein the one or more second configured grants may comprise one or more configured grant Type 1 configured grants and/or one or more configured grant Type 2 configured grants). For example, the UE monitors the PDCCH using the first RNTI to receive the indication of activation of the second transmission. Alternatively and/or additionally, the UE monitors the PDCCH, when the UE is in RRC connected state, to receive an indication of activation of the one or more second configured grants (e.g., the PDCCH may be monitored using the first RNTI to receive the indication of activation of the one or more second configured grants, wherein the activation indicated by the indication may be at a time at which the UE is in RRC connected state). In an example, the UE may activate the one or more second configured grants (when the UE is in RRC connected state, for example) in response to receiving the indication of activation of the one or more second configured grants.

In one embodiment, the UE monitors the PDCCH, when the UE is in RRC connected state, to receive an indication of deactivation of a third transmission (e.g., a third transmission, using one or more third configured grants, when the UE is in RRC connected state, wherein the one or more third configured grants may comprise one or more configured grant Type 1 configured grants and/or one or more configured grant Type 2 configured grants). For example, the UE monitors the PDCCH using the first RNTI to receive the indication of deactivation of the third transmission. Alternatively and/or additionally, the UE monitors the PDCCH, when the UE is in RRC connected state, to receive an indication of deactivation of the one or more third configured grants (e.g., the PDCCH may be monitored using the first RNTI to receive the indication of deactivation of the one or more third configured grants, wherein the deactivation indicated by the indication may be at a time at which the UE is in RRC connected state). In an example, the UE may deactivate the one or more third configured grants (when the UE is in RRC connected state, for example) in response to receiving the indication of deactivation of the one or more third configured grants.

In one embodiment, in response to receiving the second RRC message, the UE transitions (e.g., transits) to RRC inactive state and the UE stores the first RNTI. For example, the UE may transition (e.g., transit) to RRC inactive state and may store the first RNTI when the UE receives the second RRC message.

In one embodiment, the UE initiates configured grant-based small data transmission using one or more pre-configured PUSCH resources (e.g., one or more configured grant Type 1 resources) to transmit data when the UE is in RRC inactive state.

In one embodiment, the UE determines that the RNTI comprises the second RNTI based on the second RRC message comprising the second RNTI. For example, the UE uses the second RNTI to monitor the PDCCH when the UE is in RRC inactive state if the second RRC message comprises the second RNTI.

In one embodiment, the UE does not use the first RNTI to monitor the PDCCH when the UE is in RRC inactive state if the second RRC message comprises the second RNTI.

In one embodiment, the UE determines that the RNTI comprises the first RNTI based on the second RRC message not comprising the second RNTI. For example, the UE uses the first RNTI to monitor the PDCCH when the UE is in RRC inactive state if the second RRC message does not comprise the second RNTI.

In one embodiment, the UE monitors the PDCCH, when the UE is in RRC inactive state, to receive an indication of retransmission of a configured grant-based small data transmission. The configured grant-based small data transmission is performed when the UE is in RRC inactive state.

In one embodiment, the first RNTI is a first CS-RNTI and the second RNTI is a second CS-RNTI.

In one embodiment, the first RRC message is a RRC reconfiguration message and the second RRC message is a RRC release message.

Referring back to FIGS. 3 and 4, in one exemplary embodiment of a UE, the device 300 includes a program code 312 stored in the memory 310. The CPU 308 may execute program code 312 to enable the UE (i) to receive, when the UE is in RRC connected state, a first RNTI in a first RRC message, (ii) to monitor, when the UE is in RRC connected state, a PDCCH using the first RNTI, (iii) to receive a second RRC message indicative of the UE transitioning from RRC connected state to RRC inactive state, (iv) to determine an RNTI, comprising the first RNTI or a second RNTI, based on whether or not the second RRC message comprises the second RNTI, and (v) to monitor, when the UE is in RRC inactive state, the PDCCH using the RNTI. Furthermore, the CPU 308 can execute the program code 312 to perform one, some and/or all of the above-described actions and steps and/or others described herein.

A communication device (e.g., a UE, a base station, a NW node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 13-15. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 13-15, and/or one, some and/or all of the above-described actions and steps and/or others described herein.

It may be appreciated that applying one or more of the techniques presented herein may result in one or more benefits including, but not limited to, enabling a UE to monitor, when the UE is in RRC_INACTIVE state, PDCCH for one or more subsequent small data transmissions using configured UL grant and/or dynamic UL grant. Enabling the UE to monitor PDCCH for the one or more subsequent small data transmissions when the UE is in RRC_INACTIVE state may result in increased efficiency of communication between devices (e.g., the UE and/or a NW node), such as a reduction in power consumption and/or signaling overhead (due to, for example, enabling the UE to perform the one or more subsequent small data transmissions without entering RRC connected state).

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based on design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a User Equipment (UE), the method comprising:
receiving, when the UE is in Radio Resource Control (RRC) connected state, a first Radio Network Temporary Identifier (RNTI) in a first RRC message;
monitoring, when the UE is in RRC connected state, a Physical Downlink Control Channel (PDCCH) using the first RNTI;
receiving a second RRC message indicative of the UE transitioning from RRC connected state to RRC inactive state;
determining an RNTI, comprising the first RNTI or a second RNTI, based on whether or not the second RRC message comprises the second RNTI; and
monitoring, when the UE is in RRC inactive state, the PDCCH using the RNTI.

2. The method of claim 1, wherein:
the monitoring the PDCCH, when the UE is in RRC connected state, is performed to receive at least one of:
an indication of retransmission of a first transmission, using one or more configured grants, when the UE is in RRC connected state;
an indication of activation of one or more configured grants when the UE is in RRC connected state; or
an indication of deactivation of one or more configured grants when the UE is in RRC connected state.

3. The method of claim 1, comprising:
in response to receiving the second RRC message:
transitioning to RRC inactive state; and
storing the first RNTI.

4. The method of claim 1, comprising:
initiating configured grant-based small data transmission using one or more pre-configured Physical Uplink Shared Channel (PUSCH) resources to transmit data when the UE is in RRC inactive state.

5. The method of claim 1, wherein:
the RNTI is determined to comprise the second RNTI based on the second RRC message comprising the second RNTI.

6. The method of claim 1, wherein:
the monitoring the PDCCH, when the UE is in RRC inactive state, is not performed using the first RNTI if the second RRC message comprises the second RNTI.

7. The method of claim 1, wherein:
the RNTI is determined to comprise the first RNTI based on the second RRC message not comprising the second RNTI.

8. The method of claim 1, wherein:
the monitoring the PDCCH, when the UE is in RRC inactive state, is performed to receive an indication of retransmission of a configured grant-based small data transmission; and
the configured grant-based small data transmission is performed when the UE is in RRC inactive state.

9. The method of claim 1, wherein:
the first RNTI is a first Configured Scheduling RNTI (CS-RNTI); and
the second RNTI is a second CS-RNTI.

10. The method of claim 1, wherein:
the first RRC message is a RRC reconfiguration message; and
the second RRC message is a RRC release message.

11. A User Equipment (UE), comprising:
a control circuit;
a processor installed in the control circuit; and
a memory installed in the control circuit and operatively coupled to the processor, wherein the processor is configured to execute a program code stored in the memory to perform operations, the operations comprising:
receiving, when the UE is in Radio Resource Control (RRC) connected state, a first Radio Network Temporary Identifier (RNTI) in a first RRC message;
monitoring, when the UE is in RRC connected state, a Physical Downlink Control Channel (PDCCH) using the first RNTI;
receiving a second RRC message indicative of the UE transitioning from RRC connected state to RRC inactive state;
determining an RNTI, comprising the first RNTI or a second RNTI, based on whether or not the second RRC message comprises the second RNTI; and
monitoring, when the UE is in RRC inactive state, the PDCCH using the RNTI.

12. The UE of claim 11, wherein:
the monitoring the PDCCH, when the UE is in RRC connected state, is performed to receive at least one of:
an indication of retransmission of a first transmission, using one or more configured grants, when the UE is in RRC connected state;
an indication of activation of one or more configured grants when the UE is in RRC connected state; or
an indication of deactivation of one or more configured grants when the UE is in RRC connected state.

13. The UE of claim 11, the operations comprising:
in response to receiving the second RRC message:
transitioning to RRC inactive state; and
storing the first RNTI.

14. The UE of claim 11, the operations comprising:
initiating configured grant-based small data transmission using one or more pre-configured Physical Uplink Shared Channel (PUSCH) resources to transmit data when the UE is in RRC inactive state.

15. The UE of claim 11, wherein:
the RNTI is determined to comprise the second RNTI based on the second RRC message comprising the second RNTI.

16. The UE of claim 11, wherein:
the monitoring the PDCCH, when the UE is in RRC inactive state, is not performed using the first RNTI if the second RRC message comprises the second RNTI.

17. The UE of claim 11, wherein:
the RNTI is determined to comprise the first RNTI based on the second RRC message not comprising the second RNTI.

18. The UE of claim 11, wherein:
the monitoring the PDCCH, when the UE is in RRC inactive state, is performed to receive an indication of retransmission of a configured grant-based small data transmission; and
the configured grant-based small data transmission is performed when the UE is in RRC inactive state.

19. The UE of claim 11, wherein:
the first RNTI is a first Configured Scheduling RNTI (CS-RNTI); and
the second RNTI is a second CS-RNTI.

20. A non-transitory computer-readable medium comprising processor-executable instructions that when executed by a User Equipment (UE) cause performance of operations, the operations comprising:
receiving, when the UE is in Radio Resource Control (RRC) connected state, a first Radio Network Temporary Identifier (RNTI) in a first RRC message;
monitoring, when the UE is in RRC connected state, a Physical Downlink Control Channel (PDCCH) using the first RNTI;
receiving a second RRC message indicative of the UE transitioning from RRC connected state to RRC inactive state;
determining an RNTI, comprising the first RNTI or a second RNTI, based on whether or not the second RRC message comprises the second RNTI; and
monitoring, when the UE is in RRC inactive state, the PDCCH using the RNTI.
